(19) United States
(12) Patent Application Publication
(10) Pub. No.: US 2005/0278246 A1
(43) Pub. Date: Dec. 15, 2005

(54) Software solution management of problem loans

(76) Inventors: Mark Friedman, Baltimore, MD (US); Camillo Melchiorre, Moorestown, MD (US); Thomas Dungee, Columbia, MD (US); Hans Rusli, Sugarland, TX (US); Sanjeev V. Dahiwadkar, Ellicott City, MD (US)

Correspondence Address: Royal W. Craig;Law Offices of Royal W. Craig, Suite 153, 10 N. Calvert Street, Baltimore, MD, 21202, US

(21) Appl. No.: 10/867,533

(22) Filed: Jun. 14, 2004

(51) Int. Cl. G06F 17/60

(52) U.S. Cl. 705/38

(57) ABSTRACT

An improved and automated ASP-delivered loan workout system, inclusive of communication architecture and software method that assists a user in improving the dialogue and counseling sessions between user, borrower, and other involved parties, and which increases loan servicer efficiency while decreasing the time and expense necessary to process loss mitigation cases-including identification of an appropriate financial workout solution, via the use of logical decision tree-based interviews-increases the rate of identification of viable loss mitigation options, and selects and manages the best loss mitigation solution, all in real-time, and within investor and lender requirements, within loan guarantor and insurer conditions, and in compliance with rapidly changing industry standards and government rules.

### BACKGROUND OF THE INVENTION

1. Field of the invention

The present invention relates generally to delinquent-loan management systems for loan servicing processes and, more particularly, to an internet-enabled-software solution for comprehensive management of problem loans, which includes, but is not limited to, collections, loss mitigation, asset recovery (including foreclosure and repossession), and bankruptcy management, all of which is provided to subscribers via an application service provider (“ASP”).

2. Description of the Background

Not all borrowers consistently make monthly loan payments. Due to unexpected reasons, like medical expenses, unemployment, or excessive indebtedness, some borrowers suspend making loan payments for a period of months, if not altogether. Parties to delinquent loans have a number of disparate options that, with coordination, can be coalesced into a plan for resolution, one that seeks to avoid or minimize economic loss, while preserving borrower creditworthiness. For example, with regard to mortgage lenders, instead of foreclosing and acquiring the property, to the physical hardship, detriment to credit, and personal embarrassment of borrowers, lenders can institute payment forbearance, repayment plan, partial mortgage-insurance-claim-payment infusion or advance, loan modification, pre-foreclosure property sale, and deed-in-lieu of foreclosure. Borrowers can reinstate their loan, rehabilitate and preserve credit ratings, and avoid the negative social impact of home forfeiture. In principle, this concept applies to all other asset-based, delinquent-loan scenarios as well.

The execution of a delinquent-loan-resolution plan entails borrower counseling and joint lender-borrower workout sessions relating to the loan. Information is collected, compared, evaluated, and disseminated to principle parties related to the transaction. Principal parties to delinquent loan resolution include borrower, loan servicer, lender/investor, guarantor/insurer, and, to a lesser extent, support-providing vendors, or third-party providers. All resolution plans are subject to current rules of the effected loan investor (e.g., Freddie Mac, Fannie Mae, and private investor) and loan guarantor or insurer (FHA/ITUD, VA, and private mortgage insurer); all of whose continuously changing rules must be collected and applied.

In standard practice, nearly all information relating to a delinquent loan is collected by a loan servicer, who telephones principal parties and support-providing vendors. Information is assembled and then evaluated by loan service counselors, whose responsibilities include borrower interview, credit counseling, financial evaluation; likely loan disposition—unassisted reinstatement, assisted reinstatement, impossibility of reinstatement—creation of an appropriate workout solution, in light of interested lender/investor and guarantor/insurer's requirements; management consultation; dissemination of recommendations; workout-plan approval from interested parties; and implementing the workout plan, all the while balancing the activities required to recover the collateralizing asset in event a workout plan is either not feasible, cannot be initiated, or prematurely fails.

A loan servicer's attempt to resolve a delinquent loan typically includes multiple telephone borrower contact attempts (some at odd hours), dispatch of a property inspector or borrower contact agent, and multiple borrower telephone interviews; oftentimes requiring a post contact management consultation. Borrower contact or the lack thereof gives rise to the need for information from other sources, such as support-providing vendors; like a borrower contact agent, property inspector, appraiser, credit history repository, escrow/settlement agent, real estate broker, attorney, title company, and so forth. Each attempt to contact a borrower, every borrower contact, and every supporting vendor order and corresponding product gives rise to a data entry documenting the contact, order, or product.

Information gathered from a borrower's interview gives rise to several offline loan servicer activities. For example, servicers must create numerous spreadsheets to calculate the economic consequences of each workout type. The servicer must also retrieve and input loan data into said workout-specific spread sheets reflecting a fragmented, labor intensive, non-integrated process. In addition, a loan servicer must be in compliance with the constantly evolving body of loan-servicing guidelines of the concerned investor and/or loan guarantor/insurer. Servicing and guidelines undergo frequent and sometimes-dramatic changes due to government regulation, investor demands. However, few loan servicers can ensure one hundred percent compliance with current guidelines. A loan servicer's failure to offer to borrowers compliant loss mitigation alternatives can result in severe consequences to the servicer, including penalties of treble damages, and forfeitures such as the loss of the right to service the loans insured by an effected insurer or investor.

The most crucial stage in the collection and loss mitigation-solution process is the dialogue, or counseling session(s) between loan servicer and delinquent borrower. During dialogue, current borrower financials and personal information are retrieved, and later, alternative delinquent loan resolution alternatives are presented and explained. Yet the percent of successful delinquent borrower contacts by loan servicers is alarmingly low; ranging somewhere between ten to twenty percent (10-20%).

As a consequence, there is presently a great need for a system that is easily accessible by the various parties to a loan; a system that both facilitates information gathering, integration, and analysis, and leads to the determination of a guideline-compliant loan workout that mitigates losses to all effected parties.

In addition, the same investors and insurers have rigorous timeline requirements for prosecuting a foreclosure if a problem loan cannot be resolved. Because of this seemingly contradictory mission: Never stop attempting a workout and move to foreclosure sale as a rapidly as state law permits, the operational management of the problem loans has been complicated even further. Moreover, no current system facilitates the simultaneous endeavors of continuous workout efforts and expedient foreclosure processing, while providing unique, high-level and detailed loan-level views of the servicing activities so that all parties to various concurrent processes are apprised of the loan status in real-time.

The tracking of the entire spectrum of defaulted-loan servicing activities, from collections through foreclosure on the same processing platform, as that on which resides the applications to perform these activities, is not known to exist.

There have been prior efforts to improve the information available to lenders in a creditor-debtor setting. For example, U.S. patent application No. 20020046049 to Siegel et al. filed Apr. 18, 2002, shows a system and method for supervising account management operations. Using a delinquency movement matrix, Customer Service Representatives receive a promise for a payment amount for an account. The system records the baseline delinquency of the account, at the time the promise is received, retrieves updated account information, after a predetermined time period, and compares the baseline delinquency of the account to the updated delinquency of the account to determine the movement of that account through delinquency stages. Other weightings by risk factors or other variables are suggested.

U.S. Pat. No. 6,405,173 issued Jun. 11, 2002, and U.S. patent application No. 20020116244 filed Aug. 22, 2002, both to Honarvar et al. (assigned to American Management Systems, Inc., Fairfax, Va.), show a decision management system providing qualitative account/customer assessment via point-in-time simulation. The patent suggests applicability to workouts.

U.S. Pat. No. 6,098,052 to Kosiba et al. (First USA Bank, N.A.) issued Aug. 1, 2000, shows a credit card collection strategy model for use in collecting payments from delinquent accounts. The model estimates, for each possible collection strategy, how much will be paid on each account in response to that collection strategy, the amount of resources to be expended in the execution of that collection strategy, and recommends a particular collection strategy for each account, which optimizes the use of the available collection resources. This application is limited to the collection of credit card obligations, and is entirely inapplicable to the servicing of residential mortgages.

U.S. Pat. No. 6,456,983 to Keyes et al. (General Electric) issued Sep. 24, 2002, shows a method for managing disposition of delinquent accounts. Historical payment information is retained for accounts, and groups (or “types”) of delinquent accounts are defined. The delinquent accounts are scored and grouped with the high and low scores of these groups, which defines an associated score cluster or range of scores. A liquidation profile is established for each portion. When an offer is made in relation to accounts that are currently delinquent, the net present value is determined, and can be compared to an outstanding offer on a group-by-group basis. The patented system is reflected by a GE Press release at http://www.gemi. com/news/07-18-2001.html, which claims that GE Mortgage Insurance has launched the industry's first online workout approval system: Called e-LMO Fast Track, the new system combines GE's proprietary Loss Mitigation Optimizer (see above) technology with the speed of the Internet to expedite workout approvals for servicer's and investors. The system is delivered via an ASP model.

U.S. Pat. No. 6,249,775 issued Jun. 19, 2001, and U.S. patent application 20010029477 filed Oct. 11, 2001, both to Freeman et al. (Chase Manhattan Bank) shows a method for mortgage and closed-end loan portfolio management. The method aggregates loan units into loan vintages, wherein the loans in each vintage originate within a predetermined time interval of one another. The invention compares different vintages to one another in a manner such that the ages of the loans in the different vintages are comparable to one another. The results of the analysis are graphically depicted and/or automatically fed back to provide “yes” or “no” decisions regarding investments in various loan portfolios. This method essentially is a portfolio management tool for the pricing of blocks of residential mortgages.

U.S. Pat. No. 5,930,775 issued Jul. 27, 1999, and U.S. Pat. No. 6,067,533 issued May 23, 2000, both to McCauley et al. (Freddie Mac) show a method and apparatus for determining an optimal investment plan for distressed residential real estate loans based on loan data, including personal data relating to a borrower, financial information relating to the borrower's financial position, and loan conditions, including both a loan term, and information on the corresponding real estate related to a real estate-secured loan. This is an analytical tool that evaluates financial information given by a delinquent borrower coupled with the value of the mortgaged asset to arrive at a solution more economically desirable than a foreclosure. Apparently suited for Freddie Mac loans only, it does not have real-time interface with data from third-party service providers. Also, Freddie Mac's workout manager requires significant manual data input subsequent to information retrieval by the mortgage servicer's' collectors and loss mitigation specialists. Essentially, it is a limited application without real-time dynamic interaction with multiple parties or integration of data from 3rd party service providers.

In addition to the foregoing, Freddie Mac's ASP-delivered Workout Manager, at http://www.freddiemac.com/service/factsheets/womgrfm.html, enables one to analyze online an entire portfolio of pending and completed workouts. Workout Manager offers managers summary data garnered from Workout Prospector's loan-level information. Workout Manager's intended users are the managers who need portfolio level information on a daily basis. Workout Manager is available as an online application through GoldWorks network; a private network managed by AT&T. A sub module, SCHEDULER++, allows one to customize an installment and principal repayment schedule to fit almost any situation, making an opportunity out of adversity.

Despite the above, there is no known system to derive appropriate loss mitigation solutions in real-time that adheres to frequently changing industry compliance standards, that provides a portal for simultaneous participation of all principle parties-including borrower, loan servicer, lender, investor (Freddie Mac, Fannie Mae, and private investor), guarantor or insurer (FHA/HUD, VA, and private mortgage insurer), and, to a lesser extent, support supplying vendors; like a borrower contact agent, property inspector, appraiser, credit history repository, credit counselor, escrow/settlement agent, real estate broker, attorney, title company, and so forth—that improves resource availability, and that facilitates the dialogue or counseling sessions between subscriber, delinquent borrower, and all the above parties. There is also no known solution that tracks all loan servicer/lender default-servicing activities, including foreclosure bankruptcy and claims, through a multilevel global perspective whose end is to provide the complete solution to problem loan management.

The present invention solves the above problems by providing an automated ASP-delivered system and method that both assists the user in improving the dialogue or counseling sessions between the user, delinquent borrower, and other involved parties, while simultaneously increasing counselor efficiency. The invention also decreases the time and expense necessary to process loss mitigation cases, by identifying an appropriate financial workout solution via the use of logical decision tree-based interviews and by analyzing a borrower's cash flow and asset position. Therefore, the quality and quantity of loss mitigation results are improved; investor and insurer compliance is automated and the time sensitive process steps for any problem loan are tracked and monitored regardless of the eventual outcome: successful workout or foreclosure.

### SUMMARY OF THE INVENTION

The present invention solves the above problems by providing a loan workout and default servicing system comprising a software solution for problem-loan management, including fully integrated analytical tools and an ASP architecture for implementing the software to create a unified loan default process, which both brings together and facilitates the dialogue between all essential players in a loan workout situation—borrower, lender/investor, loan servicer, loan guarantor/insurer, and, to a lesser extent, supporting-service vendors-by enabling real-time interconnectivity within a community of electronic commerce for all parties with economic interests in the transactions and activities occurring during the entire default-servicing process; and by seamlessly connecting its numerous ASP-delivered business applications to trading partners and other third-party service providers.

The core of the system is a software solution that includes a graphical user interface, which both facilitates the collection and maintenance of data from various sources, and populates a database. The user interface guides a loan servicer/lender subscriber through a logical decision tree-based interview, which improves the dialogue or counseling sessions between subscriber and delinquent borrower, and prompts subscribers to complete prescribed activities; every step of which is tracked and updated in real-time for all parties to the loan workout episode. Moreover, through the Global Default System (“GDS”) component of the invention, all major and minor loan-servicing-process steps are tracked in five major sub-categories: collections, loss mitigation, foreclosure, bankruptcy and claims. Finally, in some loss mitigation results state specific legal documents may be created.

Once interview data is collected, the software applies a risk and rules-based decision engine that either fully or partially qualifies a borrower according to a hierarchy of loan workout options, all within defined constraints. Table and matrix-driven programs within the software allow loan servicer/lender users to apply their own unique rules and risk parameters to meet their specific needs. At the same time, secondary-market/investor and governmental rules and risk parameters—which qualify borrowers for workouts are preprogrammed and work in conjunction with customizable tables to provide tailored results that achieve regulatory compliance.

The system as a whole increases loan counselor effectiveness while decreasing the time and expense necessary to process loss mitigation cases, which translates into heretofore unattainable problem-loan workout efficiency; including distilling all applicable loan workout alternatives, increasing the rate at which loan workout alternatives are distilled, and prioritizing loan workout alternatives, all done in real-time. The system renders on-demand documentation of loan workout progress, it also ensures compliance for ever-changing loan-servicing rules and regulations, and it facilitates communication and commerce between the numerous parties involved in default servicing. The Global Default System component is the process-management tool that permits a company to organize, track, and measure workloads at both the macro and micro case level, to ensure operational effectiveness and regulatory compliance, regardless of whether the ultimate disposition of a problem loan is reinstatement or foreclosure and acquisition of the collateral.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a high-level flow diagram of the processes administered by the present unified loan-default software solution.

FIG. 2 is a network diagram of the ASP infrastructure for administering the unified loan-default software solution in accordance with the present invention.

FIGS. 3A-3C collectively show a functional flow diagram of the method for determining loss mitigation options in accordance with the present invention.

FIG. 4 is a screen print of the main loan information screen.

FIG. 5 is a screen print of the No Contact entry screen.

FIG. 6 is a screen print of the Promise to Pay Entry screen.

FIG. 7 is a screen print of the reason for delinquency screen.

FIG. 8 is a screen print of the questionnaire-summary screen.

FIG. 9 is a screen print of the Expenses screen.

FIG. 10 is a screen print of the regional IRS average screen.

FIG. 11 is a screen print of the borrower's income and expenses summary screen.

FIG. 12 is a screen print of the Credit Report Ordering screen.

FIG. 13 is a screen print of the Eligibility screen.

FIG. 14 is a screen print of the Calculations menu.

FIG. 15 is a screen print of the workout plan screen.

FIG. 16 is a screen print of the Manual Override form.

FIG. 17 is a screen print of the installment amounts and scheduling form.

FIG. 18 is a screen print of the NPV Results screen.

FIG. 19 is a screen print of the AVM screen.

FIG. 20 is a screen print of the Previously Calculated NPV Screen with Calculate New NPV button.

FIG. 21 is a screen print of the NPV Sales Price screen.

FIG. 22 is a screen print of the NPV Factors screen.

FIG. 23 is a screen print of the REO Sales Factor table.

FIG. 24 is a screen print of the REO Holding Period table.

FIG. 25 is a screen print of the manager settings screen.

FIG. 26 is a screen print of the NPV Results screen as in FIG. 18 showing NPV “Gain” or “Loss”.

FIG. 27 is a screen print of the AVM History screen.

FIG. 28 is a screen print of the Order New AVM screen.

FIG. 29 is a screen print of the NPV values obtained from Case Shiller Weiss.

FIG. 30 is a screen print of the report menu.

FIG. 31 is a screen print of the User Activity Report

FIG. 32 is a screen print of the Repayment Plan Analysis Report

FIG. 33 is a screen print of the Global Default System (GDS) screen.

FIG. 34 is a screen print of the Mitigation track zone.

FIG. 35 is a screen print of the layered menu.

FIG. 36 is a screen print of the modification plan interface.

FIG. 37 shows the customizable modification setup table.

FIG. 38 is a screen print of the non-FHLMC modification type

FIG. 39 is a screen print of the loan modification form.

FIG. 40 is a screen print of the hyperlinked request number.

FIG. 41 is a screen print of the open modification document in PDF format.

FIG. 42 illustrates the Pre Sale calculator.

FIG. 43 is a screen print of the Refer Case to Foreclosure Attorney link.

FIG. 44 is a screen print of the referral entry screen.

FIG. 45 is a screen print of the foreclosure track zone.

FIG. 46 is a screen print of the referral information and cover letter.

FIG. 47 is a screen print of the attorney portal.

FIG. 48 is a screen print of the attorney list of new Inbox messages.

FIG. 49 is a screen print of the foreclosure fees and costs.

FIG. 50 is a screen print of the foreclosure auction information screen.

FIG. 51 is a screen print of the foreclosure sale results.

FIG. 52 is a screen print of the attorney portal Bankruptcy track zone.

FIG. 53 is a screen print of the Bankruptcy information event tracking screen.

FIG. 54 is a screen print of the bankruptcy filing tracking area with the corresponding number of the filing

FIG. 55 is a screen print of the layered menu containing all of the tools need for each bankruptcy

FIG. 56 is a screen print of the bankruptcy payments screen.

FIG. 57 is a screen print of the date range entry screen.

FIG. 58 is a screen print of the pre-defined loan report.

FIG. 59 is a screen print of the GDS custom report filter.

FIG. 60 is a screen print of the Ready hyperlink.

FIG. 61 is a screen print of the Change Column Selection hyperlink.

FIG. 62 is a screen print of the workgroup list link.

FIG. 63 is a screen print of the User Menu with To Do List button.

FIG. 64 is a screen print of the list of loans in which an action needs to be completed.

FIG. 65 is a screen print of the interface for tracking and completion of an event.

### DETAILED DESCRIPTION OF THE PREFERRED EMBODIMENTS

The present invention is a workout system including a unified loan-default software solution for problem-loan management, and an application service provider (“ASP”) architecture for implementing the software.

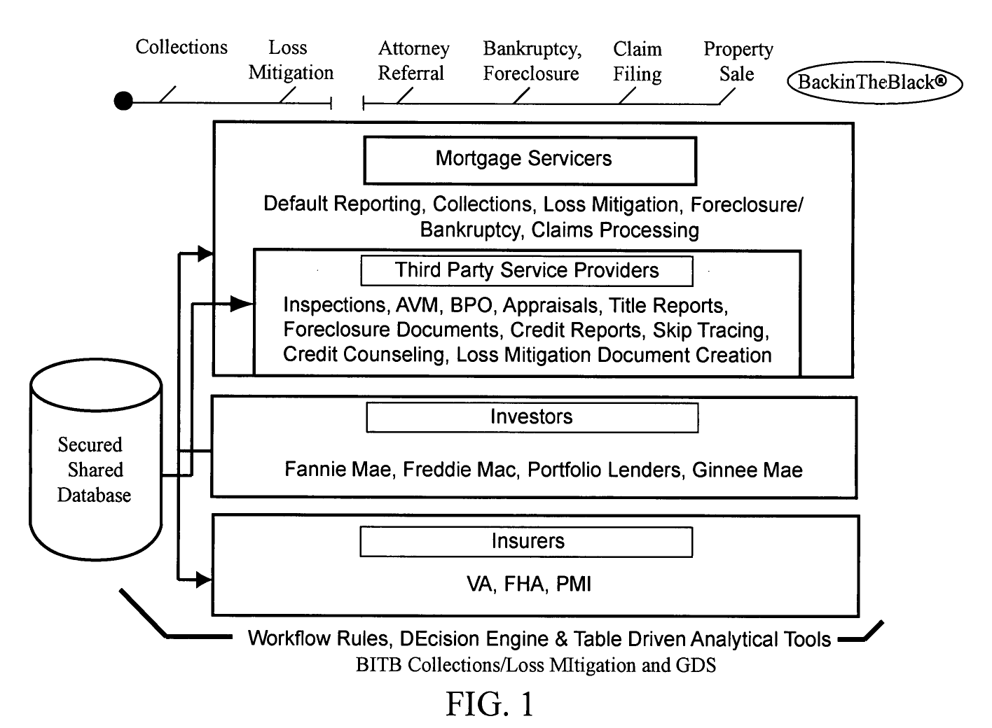

FIG. 1 is a high-level flow diagram of the processes administered by the present unified loan-default software system. The basic processes include Collections, Loss Mitigation, Attorney Referral, Bankruptcy, Foreclosure, Claim Filing, and Property Sale as shown along the timeline at top. The system brings together all principle players in a problem-loan-workout situation and presents a user-specific interface to each that facilitates the use of a knowledge base quantifying subscriber, investor, and regulatory parameters. The interface, knowledge base and software tools guide and facilitate a mutually satisfactory workout in compliance with the parameters. Moreover, the system tracks progress toward fulfillment of the workout, generates tangible results by structured querying of the knowledge base, and generates feedback reports. Thus, the system administers a turnkey loan default solution for default loan workouts and/or for cases that proceed to foreclosure and/or become subject to bankruptcy.

### Participants and/or Subscribers

The principle participants in a defaulted loan may include one or more of the following: borrower, loan servicer (identified as Mortgage Servicers in FIG. 1), lender/investor (Investors such as Fannie Mae, Freddie Mac, Portfolio Lenders, Ginnie Mae Insurers, etc.), and guarantor/insurer, and to a lesser extent, support-providing vendors (identified as Third-Party Providers in FIG. 1) such as a borrower contact agent, property inspector, appraiser, credit history repository, escrow/settlement agent, real estate broker, attorney, title company, and so forth who may find value in subscribing to the system. The software is intended for license to subscribers who will most typically be the Mortgage Servicers, and is intended for use by their loan counselors. However, all participants must register for use. The software simplifies data entry, tracking, and assessment of loan workout cases based upon predefined parameters set by the Mortgage Servicers, and then tracks the progress of a workout case, based upon recommendations within the software. The software presents a user-specific interface to each type of participant, inclusive of a graphical user interface to the loan counselors that facilitates the guided compilation of a knowledge base; which quantifies subscriber, investor, and regulatory parameters, facilitates a mutually satisfactory workout in compliance with those parameters, tracks progress toward fulfillment of a workout, generates tangible results by structured querying of the knowledge base, and generates feedback reports. The graphical user interfaces are characterized by intuitive organization and workflow: all necessary choices and supporting data are either pre-existing or defined by the user, and stored within a database library, while subscriber-desired data components may be added to the library as needed. All of the borrower, tracking and other data collected or derived during the process of FIG. 1 is stored in a Secured Shared Database (at left), which allows sharing of the data based on the user's role and authority.

### Technical Infrastructure

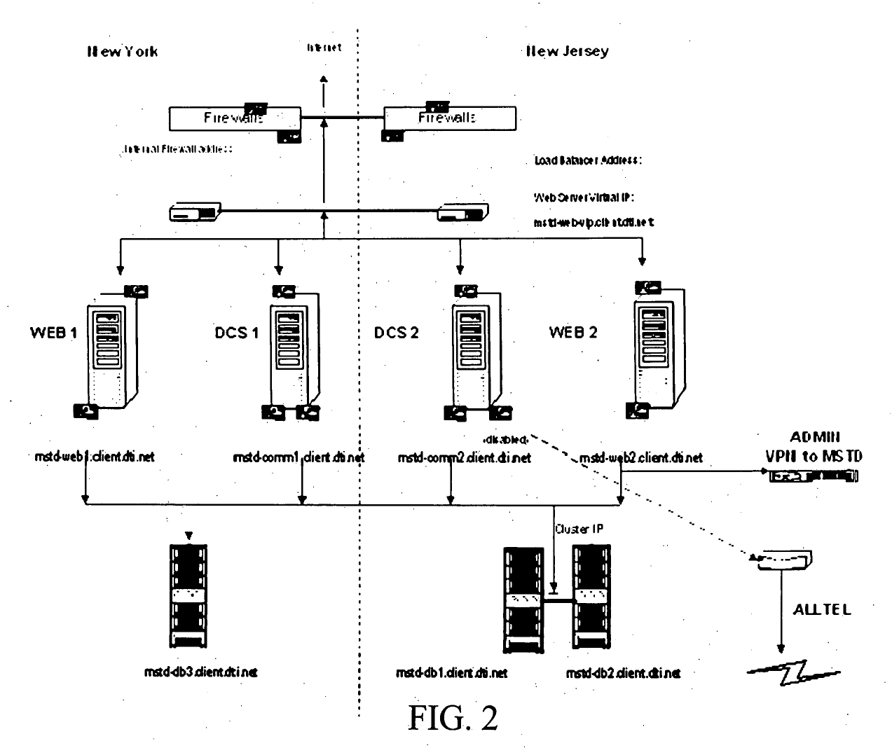

FIG. 2 is a network diagram of a suitable network infrastructure for administering the unified loan-default software solution in accordance with the present invention. The network includes: horizontally-scalable internet-enabled web servers 6 connected to the internet through firewalls 5, a robust database cluster 7 hosting an enterprise-class commercial database, and high-speed network communication devices and interfaces 8. The scalable internet-enabled web servers 6 allow web accessibility by principle parties to a defaulted loan, who may find value in subscribing to the system. The back-end robust database cluster 7 facilitates high-speed access to data concerning the defaulted loan, and centralizes the data concerning the defaulted loan where all updates by all parties mentioned occur and are visible in real-time. Conventional high-speed and redundant network equipment such as load balancers, switches, routers, cabling, and interfaces provide the ‘pipes’ by which all parties can access the system via their web client application.

### ASP Distribution Model

The foregoing network of FIG. 2 facilitates implementation of the system of FIG. 1 and distribution of the software by an ASP distribution platform.

An ASP is a vendor that supplies software applications and/or software services to customers over the Internet. An ASP rents or leases application software primarily to small and mid-sized businesses (customers). The customer's software applications and data are supported and maintained by the ASP on servers in the ASP's secure, centrally managed server facility. The ASP also handles the network's administration. Subscribers access their applications and related data via the Internet, Virtual Private Networks (VPN), dedicated leased lines (e.g., a T-1 line), or dial-up modem connections.

The ASP platform allows subscriber companies to rent the present software solution for significantly less than the cost of outright buying, deploying and supporting such in-house. Additionally, data center costs are eliminated or significantly reduced, and a company can focus on its core competencies, rather than on technology. It is not a straightforward proposition to develop an ASP model for the defaulted-loan workout industry. A successful architecture must facilitate the flow of information throughout the process, beginning with the initial borrower counseling session, continuing through to submission to investors and/or insurers, all the while both allowing dynamic changes to the information, and keeping all involved parties apprised of any action taken by any party. The present ASP platform according to the present invention accomplishes the foregoing and handles, for multiple customers' use of the system, the system's administrative needs such as network administration, maintenance, equipment upgrades, support, monitoring, backup, and contingency planning. The present ASP platform improves the dialogue between borrower and loan servicer, enhances counseling sessions, and facilitates communication and commerce between the several parties connected with default servicing case.

To use subscription software, ASP subscribers log onto the system remotely from their own terminals, giving them access to data, delinquent-loan-case assessment-based on pre-defined subscriber parameters—data entry, and progress tracking of any workout case; based on calculations from the software. Subscriber/user terminals may be workstations, personal computers (PCs), laptop computers or the like, as is known in the art.

The software facilitates all the foregoing subscriber tasks by incorporating a graphical user interface that can be viewed by any subscriber. All data collected from the graphical user interface is stored in a database, and includes cross-platform data such as 1) borrower information, 2) property information, 3) delinquency information, 4) investor/lender parameters, 5) loan guarantor/insurer parameters, 6) statistical data—living expenses, income taxes, property values, and so forth, and 7) general or regional demographic data. The collected data is stored in Oracle database tables and is made accessible through existing Microsoft products (Internet Explorer 4.0/5.0 and Access database). The preferred software allows scaling to any size site, although other databases also are suitable. For example, SQL can be used, while Microsoft Access is suitable for smaller-scale-customer bases (typically less than nine users at any one instance) with relatively small data tables.

Using the above described unified default process, subscribers can gain access to data through the internet to begin a “session” on the software supported by the database resident therein. It is also contemplated that live telephone or internet (email or videophone) communications will be carried on between users during sessions; for example, between loan counselors and borrowers.

This data is stored in database tables at the host site. Typically, each table comprises one or more records; including, for example, information about non-performing loans, such as Loan ID Number, last name and first initial of borrower, date of loan, social security number, and default date. Each of these categories in turn represents a database field. During any session, authorized subscribers can input loan and credit-related data into the database, search the database in response to requests from any user, and modify the database in response to communication between any user and a borrower. In a preferred embodiment, at least the following information is included within each of the seven categories:

1) borrower information: social security number, mailing address, e-mail address, fax number, telephone number(s), and cell-phone number;

2) property description: information about the collateral property, including street address, location, assessor's parcel number or property tax i.d. number, recorded-property deed book and page numbers, original loan-to-value ratio, current market value, condition, and occupancy status;

3) loan delinquency information: loan-servicer person code (indicating user or users permitted access to a loan), loan number, loan type, investor (Fannie Mae, Freddie Mac, lender), loan terms, loan guaranty or mortgage insurance, loan-payment history, unpaid principle balance, accruals, escrow account balance, status of default, e.g., forbearance, foreclosure, or bankruptcy, and current loan-to-value ratio);

4) investor/lender parameters;

5) loan guarantor/insurer parameters;

6) living expenses, income taxes, property values, and so forth; and,

7) general or regional demographic data.

In addition, other information is retained, such as current session information, a borrower contact history, notes recorded during interviews, communications and products rendered by support-supplying venders, loss mitigation solutions offered—such as forbearance, repayment plan, loan modification, partial mortgage insurance claim infusion, pre-foreclosure sale, or deed-in-lieu of foreclosure decision justifications, financial details relating to a solution, proposed debt-management plan details, credit reports, and so forth.

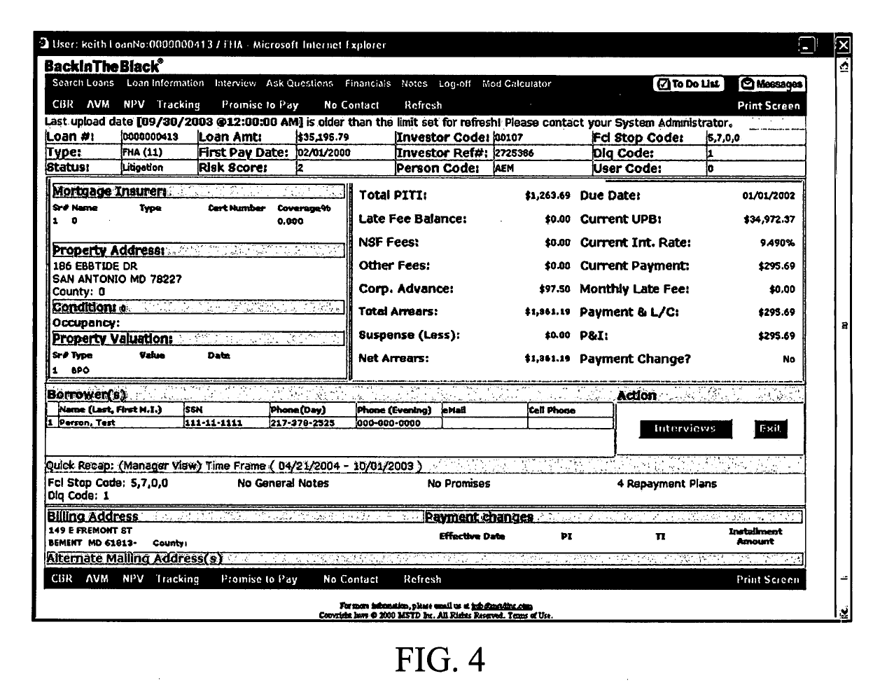

In use, a subscriber starts a session by initiating the software and logging in. The software includes a login module responsible for user i.d. and password checking. In particular, the software controls a user's access to the system by comparing user i.d. and password data to data stored in the database. Additionally, the login module is responsible for assignment of a particular authorization level with a corresponding interface to serve the client. For example, each loan servicer station is serviced by a loan-servicer user interface; each borrower station is serviced by a borrower user interface; each vendor station is serviced by a vendor user interface; and, each creditor station is serviced by a creditor user interface. As a session continues, all seven categories of information can be input, viewed, and edited, depending upon a user-authorization level, via a user-specific interface. Upon initial login a loan counselor is presented with the loan information screen illustrated in FIG. 4.

### Collection Process Outcomes

There are five potential outcomes of an initial collections effort: 1) attempted conversation with borrower but no contact, 2) communication with borrower who agreed to reinstate the loan, either immediately or by virtue of a promise to pay on a specified future date, 3) a counseling session where the borrower fully qualifies to repay the delinquent amount over a prescribed period of time, 4) a counseling session where the borrower prequalifies for one or more investor prescribed problem loan workouts, and finally, 5) a counseling session in which a borrower cannot qualify for any loan workout and must be referred to foreclosure, notwithstanding continuous triage efforts to resolve the problem loan prior to foreclosure. The five potential outcomes of an initial collections effort are detailed below.

### No Contact

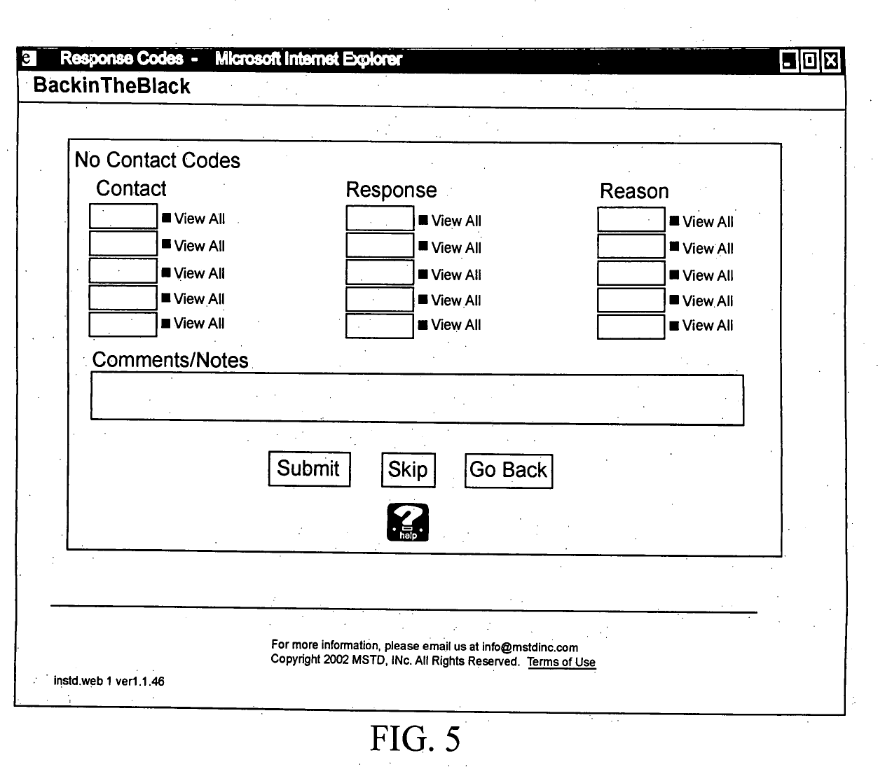

In the event that no contact is made with the borrower, the user may document this by clicking the No Contact link on the loan information screen (FIG. 4). This calls the No Contact entry screen (FIG. 5), in which the user may enter free form comments and reason, response and contact codes. These codes are then submitted to the main servicing system when the user clicks the Submit button.

### Promise To Pay

When a borrower is contacted and the loan counselor negotiates a payment promise to reinstate a delinquent loan, the reinstatement takes the form of a Repayment Plan.

A Repayment Plan allows a qualified borrower to repay the delinquent amounts due on the loan over a period of time that usually does not exceed 6 to 12 months. The borrower will also be responsible for continuing to make the regular monthly payment on the specified due date.

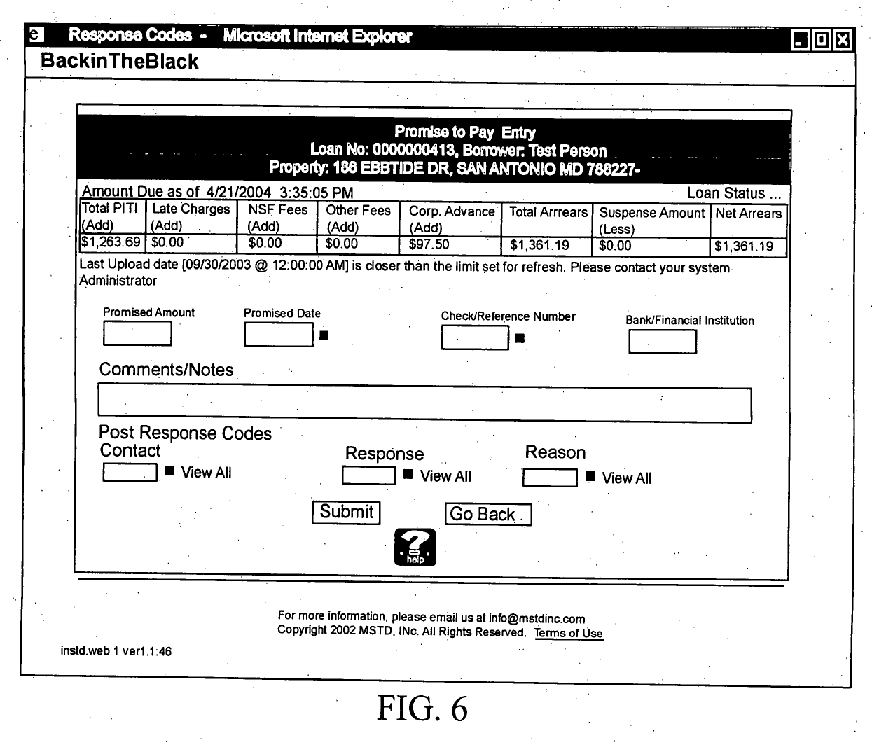

All of the foregoing Repayment Plan options are documented in the Promise to Pay Entry screen (FIG. 6). The Promise to Pay Entry screen allows the user to document the promise to pay amount and date. Other information such as check number, bank or financial institution and comments may also be entered. The user completes the promise to pay by entering reason, response and contact codes and clicking the Submit button. These codes and the information gathered post back to the servicer's main system of record upon submitting and are also recorded in the invention. The results are compiled back and are displayed in the Quick Recap section of the loan information screen as shown in FIG. 4.

When a borrower is contacted and the loan counselor cannot negotiate a payment promise to reinstate a delinquent loan, he initiates a Collections Interview Process (to be described) in order to evaluate and attain on of the other four potential workout solutions, including:

Special Forbearance Plan

A Special Forbearance Plan allows a qualified borrower to enter into a written repayment agreement that contains a plan to reinstate the loan. In most cases, this plan may not exceed 18 months. This plan allows more flexibility in the amounts due each month and may also be used in conjunction with another workout solution (described below) such as a Partial Claim or Modification.

Loan Modification

A Loan Modification is a permanent change in one or more of the terms of the borrower's loan. The loan modification allows the loan to be reinstated and results in more affordable terms for the borrower. Modifications may include a change in the interest rate, capitalization of most of the delinquent amounts, extension of the maturity date and/or re-amortization of the balance due.

Partial Claim (available for HUD/FHA insured loans only)

Under the Partial Claim option, a mortgage company will advance funds on behalf of the borrower in an amount necessary to reinstate the mortgage loan. The borrower will execute a promissory note (for the amount of the advanced funds) and subordinate mortgage payable to the U.S. Department of Housing and Urban Development (HUD).These promissory notes currently carry no interest and are not due and payable until the loan pays off or when there is a change in ownership.

Pre-Foreclosure Sale

A Pre-Foreclosure Sale allows a borrower-homeowner to sell the property and use the sale proceeds to satisfy the amount due on the mortgage even if the amount is less than what is owed. This workout solution is appropriate for borrower-homeowners whose financial situation requires that the property be sold, but are unable to sell without relief, because the value of the property is less than the amount owed to pay off the loan.

Deed In Lieu Of Foreclosure

A Deed In Lieu of foreclosure allows a borrower-homeowner to voluntarily transfer ownership to the mortgage company. The borrower-homeowner is usually asked to sign a deed that transfers title to the property to the mortgage company. In most cases, the borrower—homeowner is released from all obligations under the mortgage.

### Collections Interview Process

The following is a description of a typical software session, described from the perspective of a mortgage servicer and a loan-servicing specialist undertaking a loan counseling session.

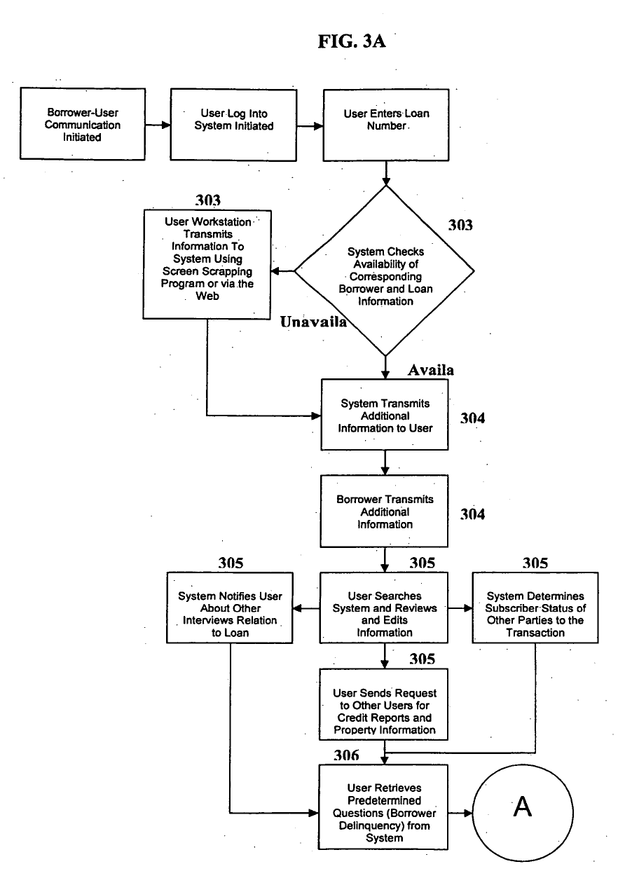

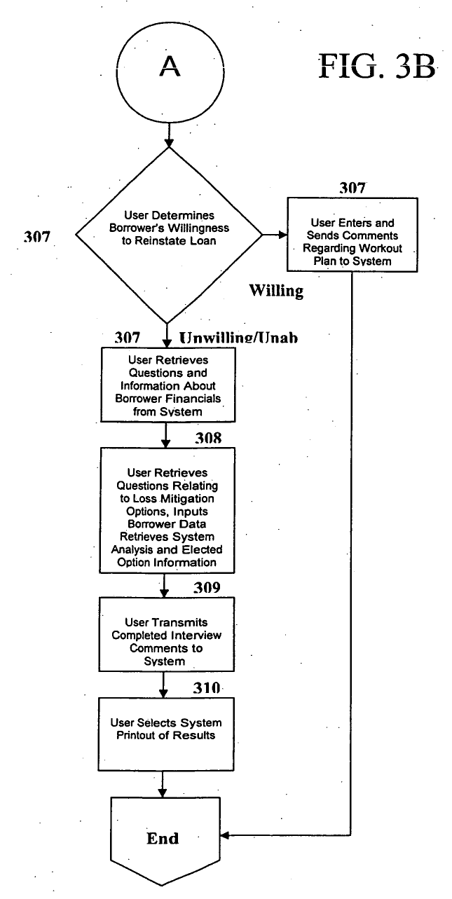

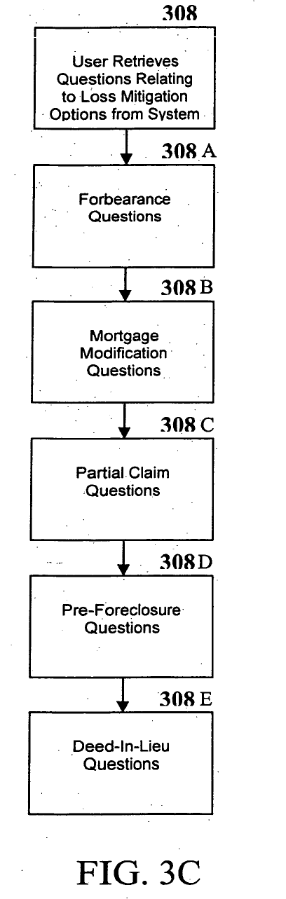

FIGS. 3A and 3B collectively show a functional flow diagram of the method for determining loss mitigation options in accordance with the present invention, as enabled by the software and employed by a loan-servicing specialist. Preferably, the method is performed while a loan-servicing specialist is communicating by telephone or otherwise in real-time with a borrower regarding a delinquent loan. A loan-servicing specialist accesses the system to conduct traditional outgoing calling campaigns, and to process both incoming borrower calls, and borrower data records.

As seen in FIG. 3A at step (hereinafter “at step”) 301, communication occurs between (a) loan-servicing specialist and (a) borrower; beginning typically by loan-servicing specialist contacting borrower, or vise versa, to work out a loss mitigation solution and debt management plan relating to borrower's delinquent loan. At login 302, loan-servicing specialist accesses system, which verifies that the station is authorized to access the system. In this step, the application transmits any access control data or other data needed to initialize a loan-servicing station, so as to customize it for access by that specific loan-servicing specialist. In the world-wide web environment, a loan-servicing specialist accesses the system's website homepage and selects the appropriate user module, which is connected to a portal pathway. The selection connects a loan-servicing specialist to that user's welcome page, where the user is prompted to provide a unique user i.d. and password. A user can change a password anytime.

At 302a, loan-servicing specialist enters borrower's loan number.

At 303, the system loads such corresponding loan information as it has, from the database, to loan-servicing specialist's station. If information is not available, then at step 303a, loan servicer searches for information in the database.

Simultaneously, at step 304, loan-servicing specialist's workstation receives notification that the information is now available.

At step 304a, borrower provides additional information about the subject loan (in particular, the reason for delinquency) via the telephone or borrower workstation (via e-mail or otherwise). In particular, borrower accesses the system's website homepage and selects a borrower module that is connected to a portal pathway. The selection connects borrower to the borrower-welcome page, where borrower is prompted to provide his/her social security number, loan servicer's name, and loan account number. Next, borrower is connected to the application, where file data, query, and security software is loaded, and borrower is queried to enter loan and borrower data. On completion of data entry, data is encrypted by security software and forwarded to application for processing. Simultaneously, the user workstation receives notification that such information is now available.

At step 305, while the user is interviewing borrower, the user performs a loan and financial-data search relating to borrower. The user next inputs, searches, reviews, or edits loan information and forwards results into the system. The user also can periodically perform a search on updated contents of the database, and notify user of the revised-search results.

Concurrently, at 305a, the system notifies the user about any other interviews relating to the subject loan. The user can view results of the interview, including comments and recommendations of other users, if available. The user then can decide whether to continue working with the currently open interview or start a new interview.

At step 305b, the user also can send requests to credit counselors or supporting-service vendors, for credit, property valuations, and title reports.

At step 305c, the system determines, through subscriber software, whether other parties to a transaction—such as loan servicer, credit counselor, or vendor(s)—are system subscribers. If a party is a subscriber, data is reformatted and sent to that party. If a party is not a subscriber, that party is contacted to determine its level of interest in purchasing non-confidential borrower-related data or becoming a subscriber.

At step 306, the user retrieves a script of predetermined questions—whose multiple-choice answers describe both the reason for delinquency (such as unemployment, loss of other income, domestic problems, excessive use of credit, death in the family, infirmity, property defects, property sale, and so forth) and borrower's financial predicament—and from a user workstation conducts a scripted interview with borrower; whose answer's are transmitted to the system. As each scripted question is answered by the borrower and the input is entered by the user, a subsequent question is transmitted to the user. The answers are then forwarded for storage in the application's database.

At step 307, user determines borrower's willingness to reinstate subject loan. At step 307a, if borrower is willing to reinstate, user selects the promise to pay tab and enters the agreed-upon loan workout plan at user's workstation, which is forwarded for storage in the application's database; indicating a successful resolution of the delinquency, the amount borrower is paying, and the follow-up date.

At step 307b, if borrower is unable to promptly reinstate, the system transmits to user an alternative questionnaire; predetermined by loan servicer from a group of interview queries residing in a database relating to loss mitigation options. User then questions borrower and enters information regarding borrower's present and anticipated financials; including monthly income and expenses. There is also a facility to incorporate future income and expenses into the cash flow analysis if reasonably certain these items will materialize, i.e. tax refund or the initiation of alimony payments this is accessible only in the detailed financial form. This information is also saved in the system's database.

IRS-sourced statistical median-family income and expense data, borrower's past financials, income streams, and payment history for use in rendering a comparison of current financials with that of the last (two) delinquencies. The system also stores borrower-specific information—such as unpaid principle, late charges, and reinstatement fees—and calculates median living expenses based upon the sum of borrower's dependants, number of cars owned, and so forth; which are filled-in on screen while the user is working out loss mitigation alternatives with borrower.

At step 308, the user retrieves a loss mitigation-alternatives questionnaire to assist the user in exploring various loss mitigation options. Based upon borrower's replies, the system indicates applicable loss mitigation options and displays those options at the user's workstation, including why the various options are either available or unavailable.

At step 309, at the user's workstation, the user ends an interview, edits and validates data, and inputs comments and recommendations regarding data. When complete, the user transmits completed information for storage in application's database.

At step 310, the application provides the user with the option of selecting a print-out of interview results.

FIG. 3C shows a specific process-flow diagram in the mortgage-servicing environment that, in addition to practicing steps 301-310 of FIGS. 3A&B, includes further detail to step 308 above and is designated as steps 308a-e, as follows: At step 308a, if the user decides to workout a payment forbearance with borrower, by selecting that option at the user's workstation, the system transmits questions relating to forbearance to the user's workstation. If all borrower responses recorded by the user's workstation are in favor of forbearance, then the user can conclude the interview as a successful forbearance.

At step 308b, if the user decides to work out a mortgage modification with borrower, by selecting that option at user's workstation, the system transmits questions relating to mortgage modification to the user's workstation. If all borrower responses recorded at user's workstation are in favor of a mortgage modification, then user can conclude the interview as a successful mortgage modification.

At step 308c, in the event borrower fails to qualify for a payment forbearance or mortgage modification, the system transmits questions relating to other options; in the descending preference of partial-claim payment or advance, pre-foreclosure sale, and deed-in-lieu.

If user decides to work out a partial-claim payment or advance with borrower, by selecting that option at user's workstation, the system transmits questions to user's workstation relating to a partial-claim payment or advance. If all borrower responses recorded at user's workstation are in favor of a partial-claim payment or advance, then user can conclude the interview as a successful FHA partial claim.

At step 308d, if user decides to work out a pre-foreclosure sale with borrower, by selecting that option at user's station, the system transmits questions relating to pre-foreclosure sale to user's workstation. If all borrower responses recorded by user's workstation are in favor of a pre-foreclosure sale, then user can conclude the interview as a successful pre-foreclosure sale.

At step 308e, if user decides to work out a deed-in-lieu of foreclosure with borrower, by selecting that option at user's workstation, the system transmits questions relating to deed-in-lieu of foreclosure to user's workstation. If all borrower responses recorded at user's workstation are in favor of a deed-in-lieu of foreclosure, then user may conclude the interview as the borrower qualifies for FHA's deed-in-lieu.

The software of the present invention fully administers the foregoing method quickly and easily via a graphical Index tab interface, as shown at the top of the loan information screen of FIG. 4. The Index tab interface comprises a series of selectable index tabs (at the top), including Search Loans, Loan Information, Interview, Ask Questions, Financials, Notes, Logoff, MOD [modification] Calculator, and Notes; each of which provide direct access to selected modules. A user is free to navigate modules in any order desired; however, index tabs are arranged left to right, to sequentially guide a user through the foregoing data entry, review, and analysis steps needed to produce a useful and comprehensive result. The Index tab interface remains visible within every screen.

Loans can be searched and retrieved using the Search tab (top left).

When a loan is retrieved and displayed via the loan information screen of FIG. 4, the loan information screen provides a capsule summary of all pre-entered information for the subject loan, including a risk score. With comprehensive information displayed, a loan workout specialist can make well-informed decisions on how to handle a workout. Selection of a Notes button at the bottom of the page opens a notes-field entry window, in which such things as prior workout efforts are detailed.

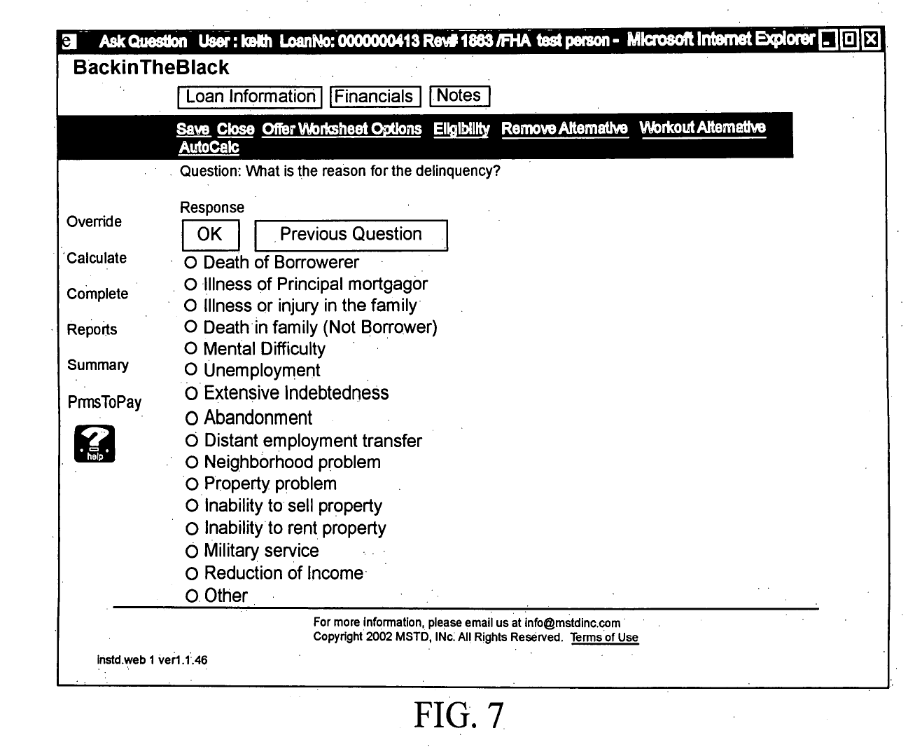

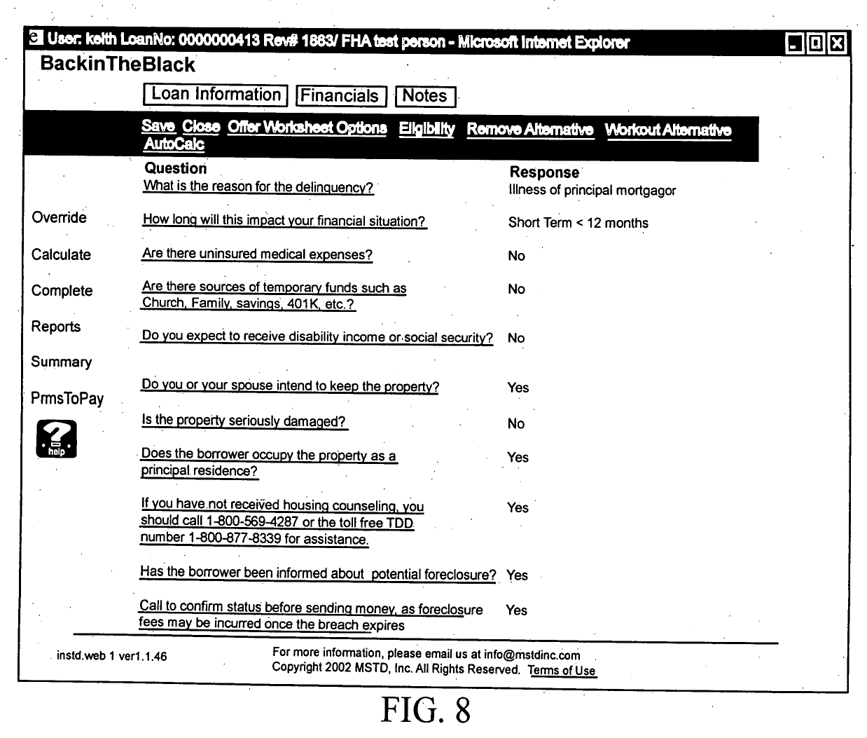

If a loan specialist decides to interview a borrower, they need only select the Interview tab on the loan information screen of FIG. 4, and this engenders a series of loan interview screens that walk a loan specialist through a series of borrower questions, including the reason for delinquency (as seen in FIG. 7), property occupancy, borrower's intent with regard to property ownership, and so forth. Answers to questions are entered by selecting appropriate buttons as in FIG. 7. Results are tabulated and are viewed on the questionnaire-summary screen shown in FIG. 8.

### Financial Information Gathering

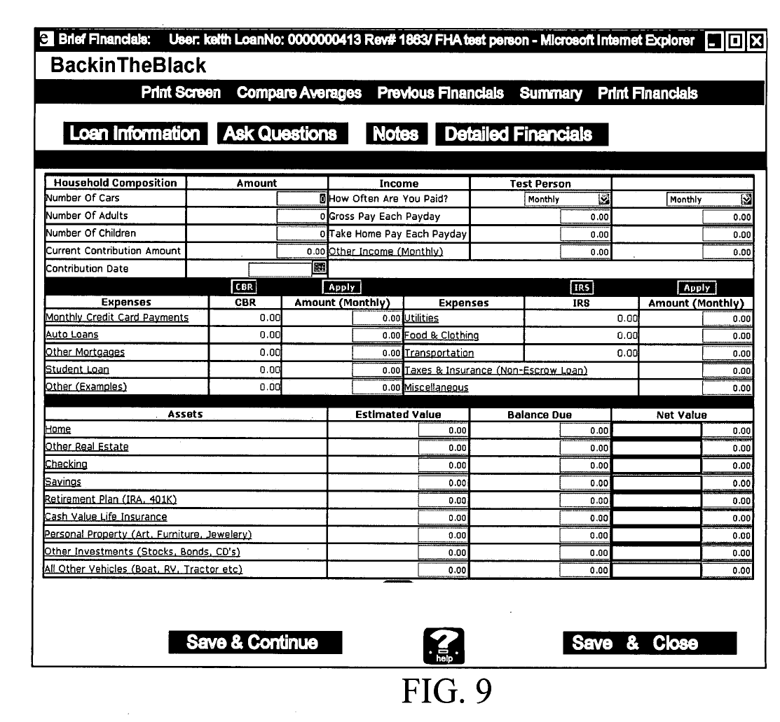

By clicking the Financials tab on the Ask Questions screen of FIG. 7, a loan workout specialist is confronted by a borrower income screen, as shown in FIG. 9. Borrower income is expressed periodically, but is convertible instantly to monthly income.

Expenses can be viewed and/or entered, as shown in FIG. 9. A borrower's immediate-family composition and number of cars owned are entered, so that actual or statistical expenses for food, clothing, utilities, and transportation can be entered or calculated for analysis.

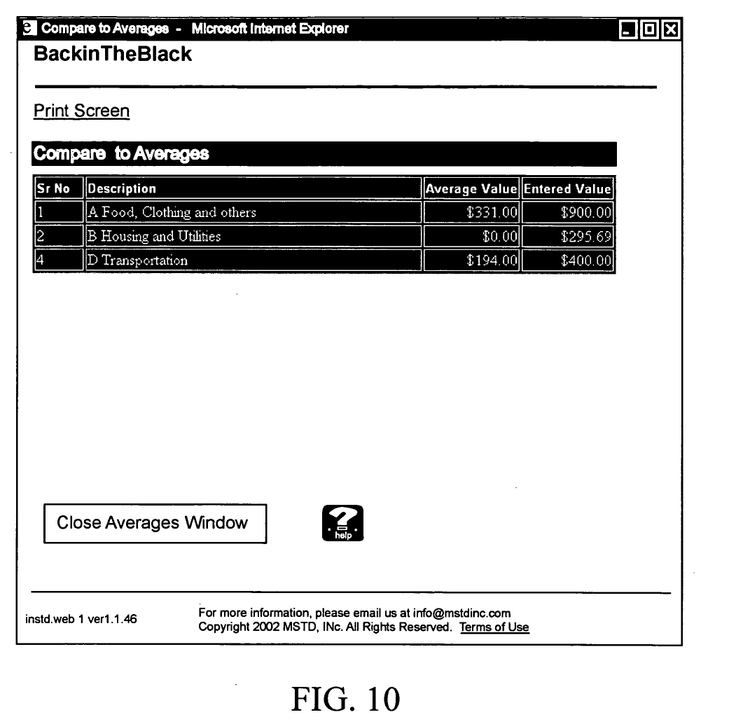

By selecting the Compare Averages link, at the top of FIG. 9, borrower's income and expenses are automatically compared to regional IRS averages for similar families in the same geographic area, as shown in FIG. 10. This comparison helps collectors better judge the borrower's actual ability to maintain a valid repayment plan.

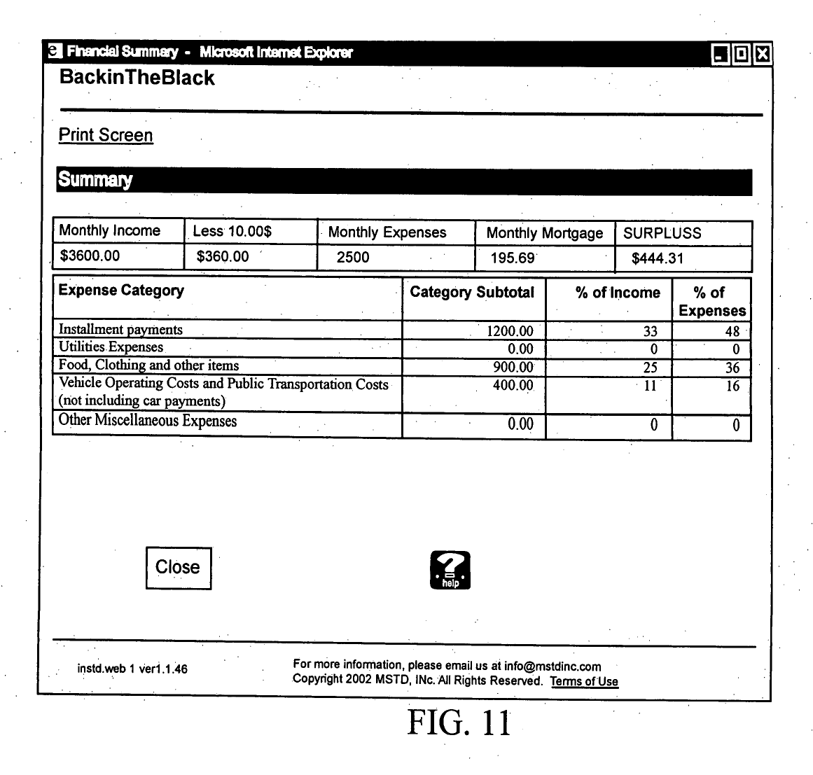

The financial summary screen is accessed by clicking the Summary link on the Financial screen shown in FIG. 9. The Summary screen (FIG. 11), breaks down borrower's income and expenses, and calculates the ratio of expenses to income.

### Credit Report Integration

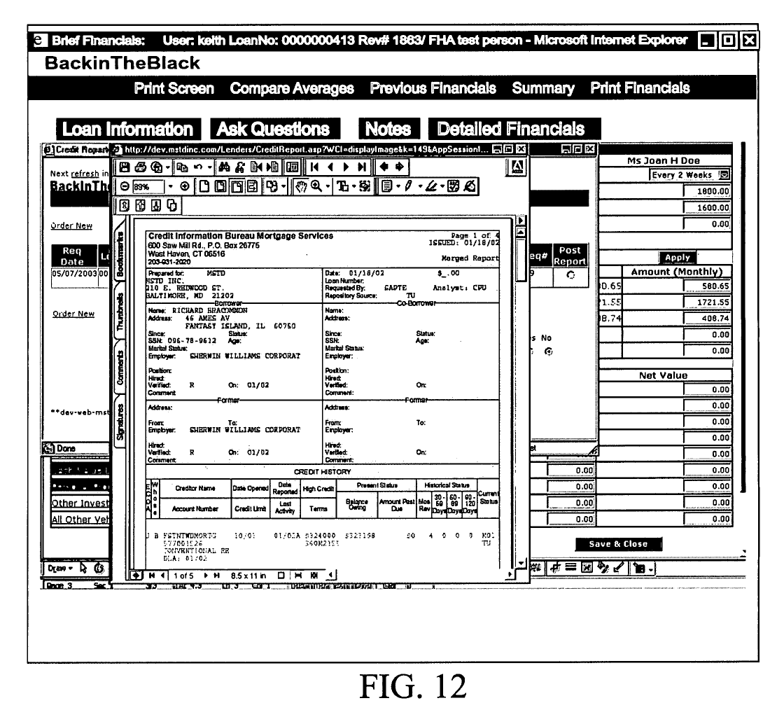

FIG. 12 illustrates one of the most powerful features of the present invention: Previously, loan servicers were unable to order credit records while speaking by telephone with a borrower. The present invention enables a loan specialist to electronically retrieve a borrower's financial data, in real-time, and integrate that information into a decision engine, if and when a specialist chooses. The Credit Report Ordering screen is accessed by clicking the CBR button shown on the left of the main loan information screen (FIG. 4) or in FIG. 9. Once ordered, the credit report is downloaded in real time from the selected source (a number of online credit reporting agencies provide this capability). Once retrieved, the credit report is stored in the database as an Adobe *.pdf file, for full image viewing, while data elements can be selectively migrated into the loan record by selecting appropriate buttons.

### Borrower Eligibility for Workout Options

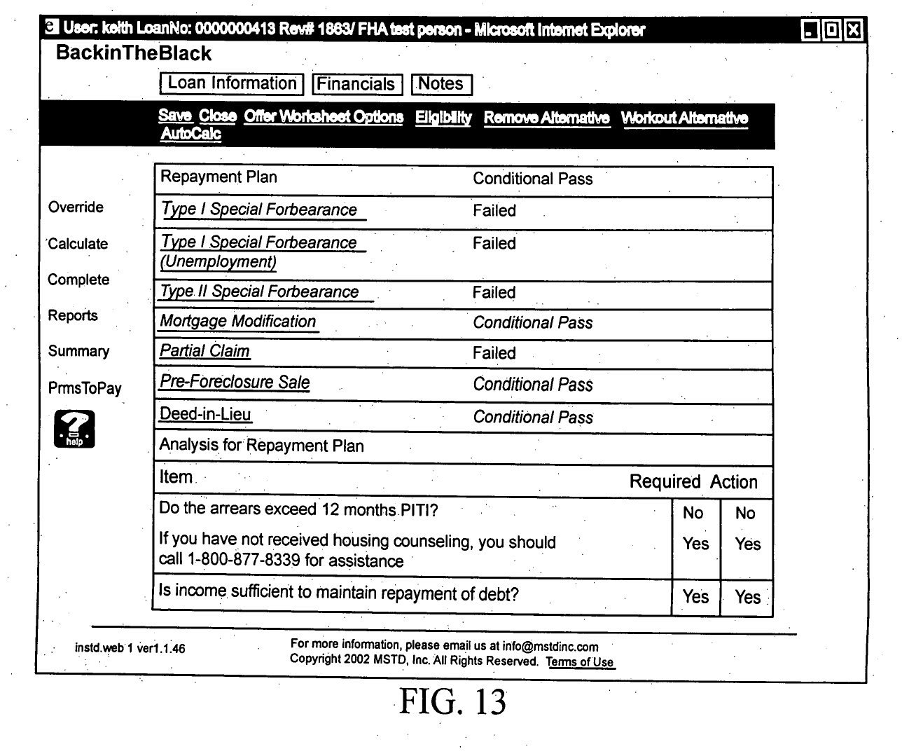

Having assembled the foregoing information—from borrower-answered questions, actual and statistical expenses, and a credit report—a loan specialist may then select the Eligibility link from the question summary screen FIG. 8, which invokes an Eligibility screen as shown in FIG. 13. The Eligibility Screen instantly displays the investor specific loan workout hierarchy with a determination as to which allowable options the borrower has either conditionally passed or failed. By clicking the conditional pass or fail hyperlink the criteria upon which the decision was made are displayed.

Generally, the user will attempt to perfect the highest and best solution: repayment plan by clicking the Calculate link at left (FIG. 13), which calls the repayment plan calculator described below.

### Repayment Plan Calculator

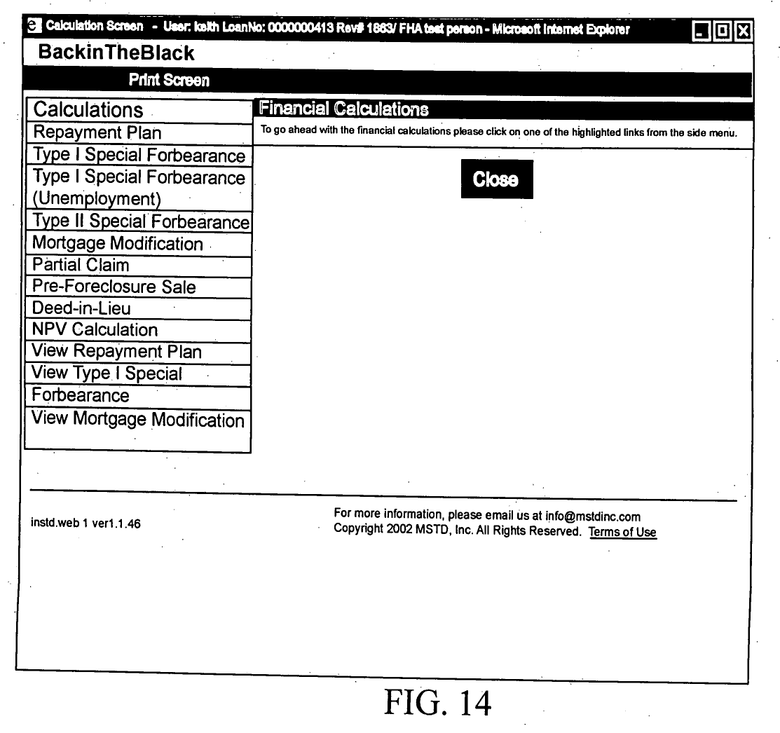

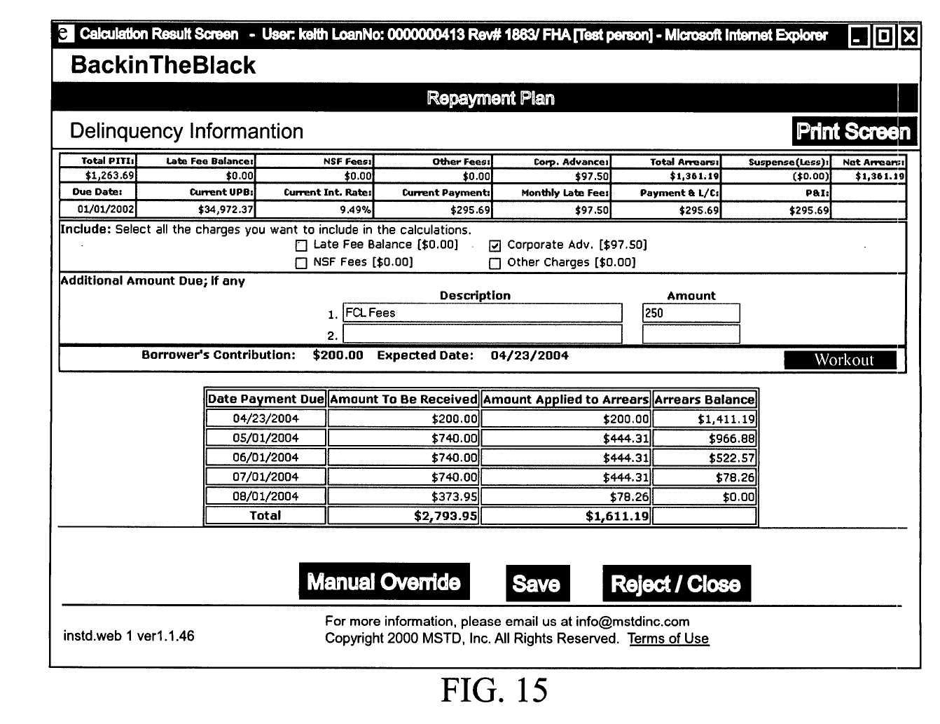

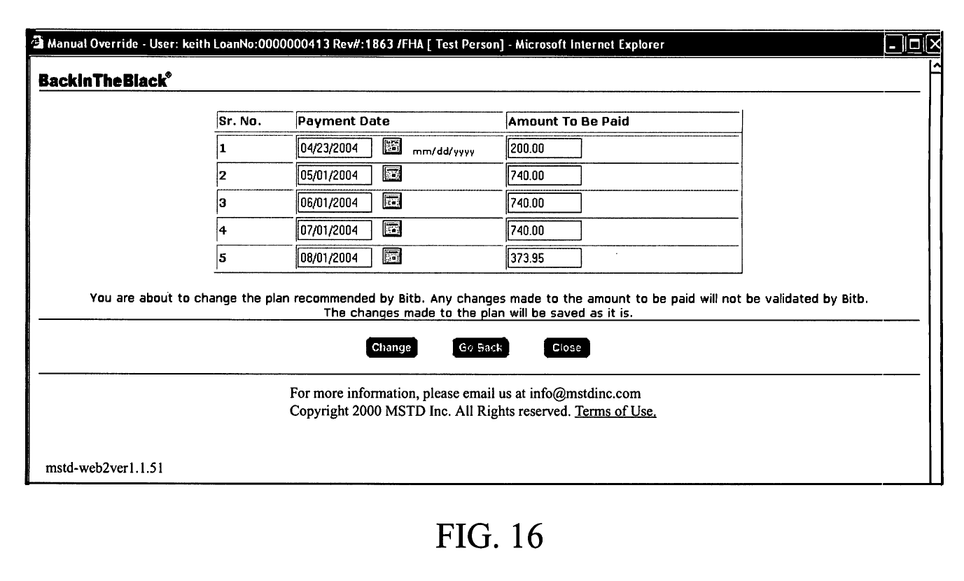

The present software integrates a repayment plan calculator that creates a repayment plan based on the outcome of the financial gathering process and investor requirements. The user may access the repayment plan calculator by clicking the Calculate link on the Eligibility screen (FIG. 13). This calls the Calculations menu of FIG. 14, which offers the option of clicking the Repayment Plan link at the top of the Calculations menu (FIG. 14). This accesses the repayment plan calculator of FIG. 15, which provides a variety of options by which the user may include extra fees accrued in the system and/or manually enter additional amounts to be included in the plan. By clicking the workout button (right center), the plan is displayed as shown below the horizon of FIG. 15. The contribution amount, if present will appear as the first installment of the repayment plan (shown highlighted in gray). Users, with specified authority may override plan dates and amounts by clicking the Manual Override link (bottom left) and completing the ensuing override form as seen in FIG. 16.

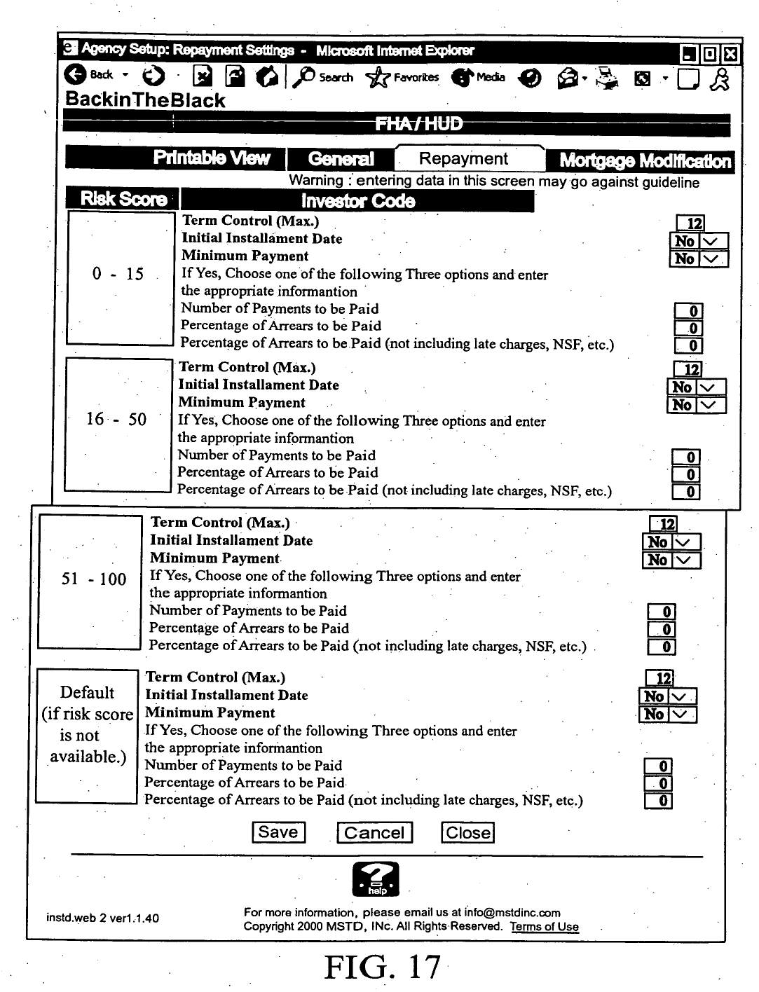

Repayment plan parameters and settings can be applied by loan type. Controls based on risk scoring for length of plans, installment amounts and scheduling of the first payment are available (FIG. 17). These controls are accessed by logging on as a Manager and then completing an Agency Setup form.

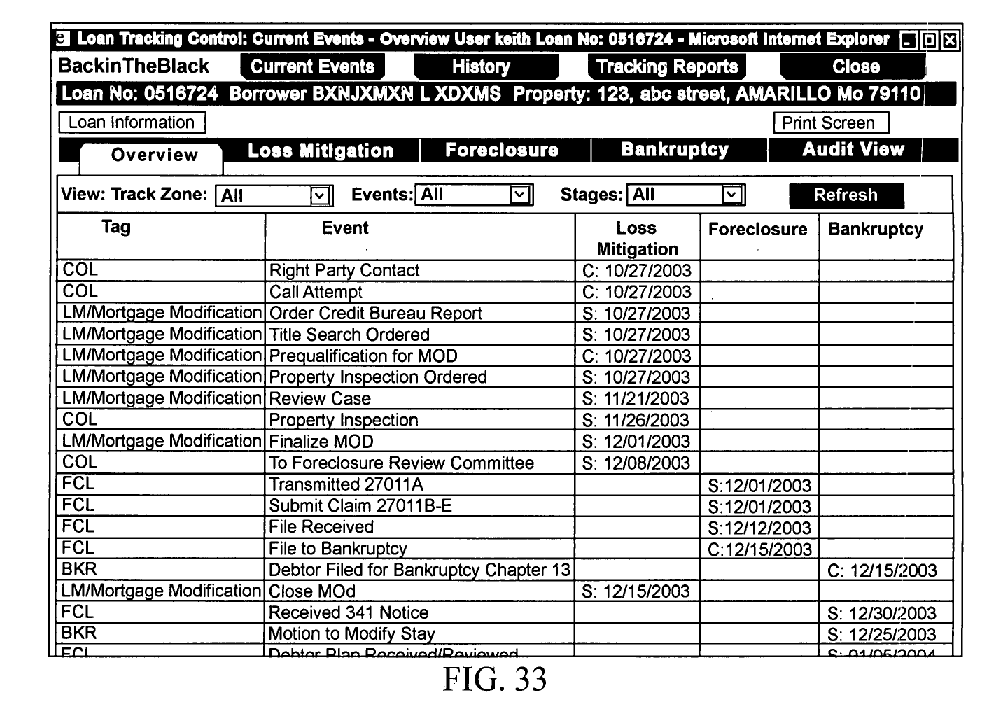

If the borrower is not eligible for a promise to pay or repayment plan, the user will then attempt to perfect each succeeding conditionally passed workout option (see Eligibility screen of FIG. 13) to determine which one the borrower fully qualifies. If the borrower fully qualifies for a workout, the process to close the workout is tracked and monitored via a Global Default System (GDS) component of the invention shown in FIG. 33 and described more fully below. On the other hand, if the loan problem goes to foreclosure it must be processed, tracked and monitored to completion, i.e. foreclosure sale and claim filing.

### Net Present Value Calculator

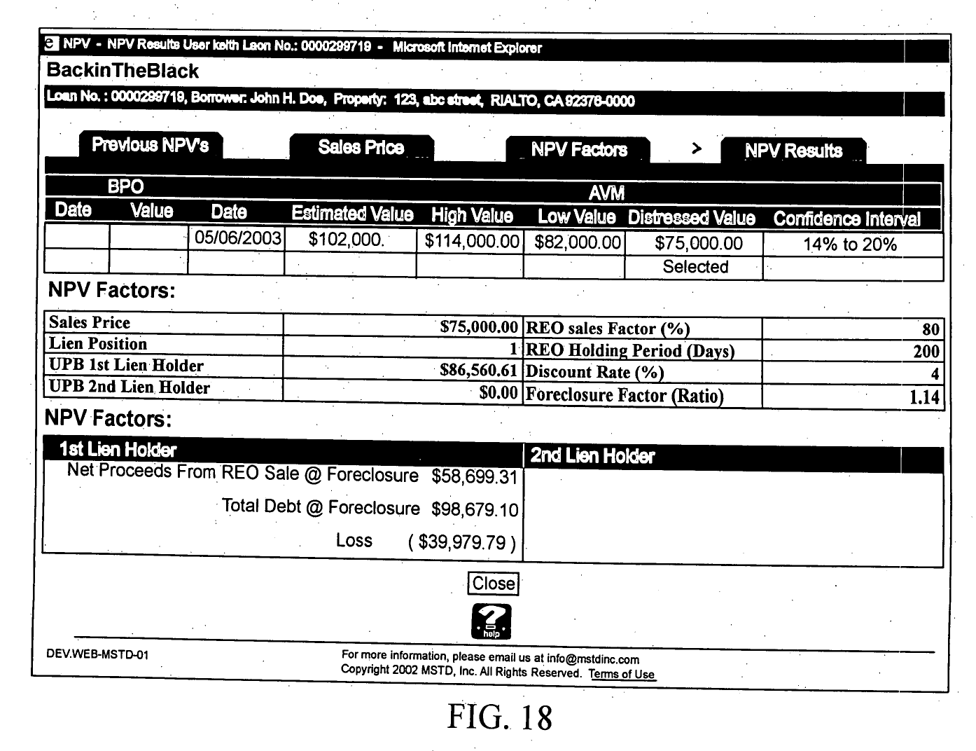

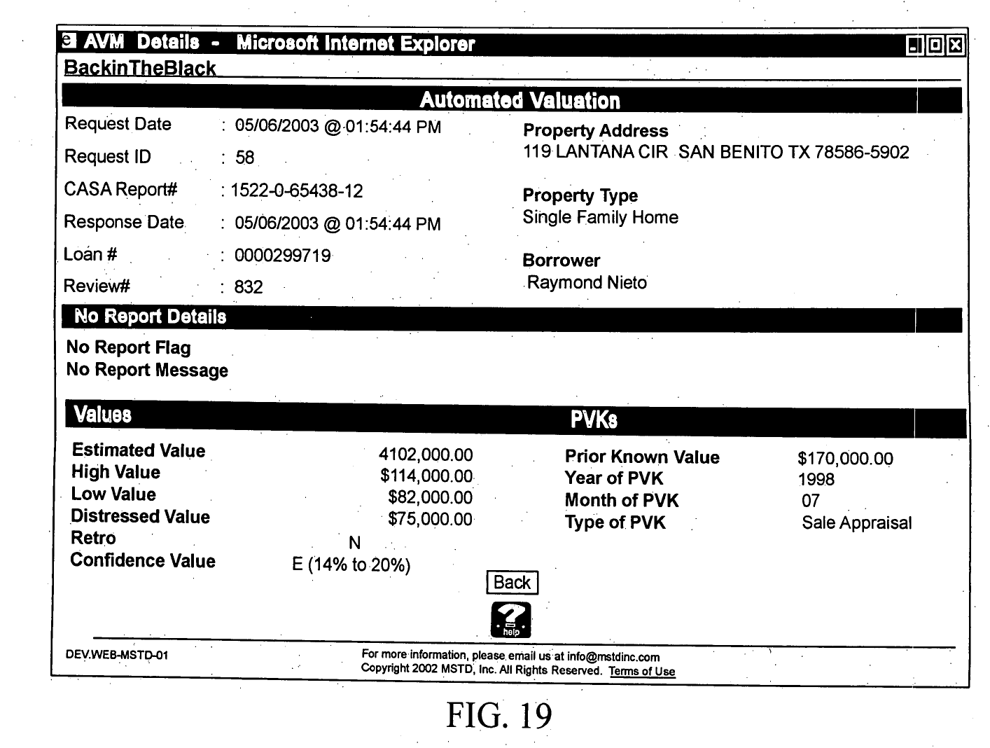

The Net Present Value (NPV) function of the invention offers mortgage servicers a utility to calculate their exposure in a foreclosure situation, thus allowing them to take the proper action now to minimize their losses. Traditionally, mortgage servicers performed this task by collecting all the different expenses from countless number of sources just to calculate the total debt of the loan at different periods in the foreclosure process. Often, the meticulous task of collecting this information would go to waste when an inaccurate sale price or holding period was forecasted. While this is still a viable method of calculating potential losses in a foreclosure situation, it is time consuming and costly. The invention's NPV calculator takes advantage of its web-based properties, the ability to gather information in real time to provide a mortgage servicer with an instantaneous and a cost effective method of calculating expected losses. A loan specialist can quickly view previous net present value calculations from the main loan information screen of FIG. 4 by clicking the NPV link, which opens the NPV Results screen of FIG. 18, and displays its summary of the subject property's value and recorded liens. The NPV results are shown and may be accessed in more detail by clicking the NPV's hyperlinked date (May 6, 2003), which leads to the AVM screen shown in FIG. 19. Property values are calculated automatically using an Automated Valuation Model (AVM). An AVM is a statistically based market valuation of a property, which is security for a problem loan. An AVM calculates a statistically reliable price range for residential properties, based on the sales activity of similar properties in their immediate neighborhoods, and other factors such as municipal assessment value, and produces a valuation consistent with these factors. An array of third-party vendors offer suitable AVM services including Casa (Case Shiller and Weiss), HPA (Mortgage Risk Assessment Corp.), HVE (Freddie Mac), PASS—Basis 100 (Solimar), and Valuepoint (First American). Once displayed, calculations can be manually adjusted in the AVM screen of FIG. 19.

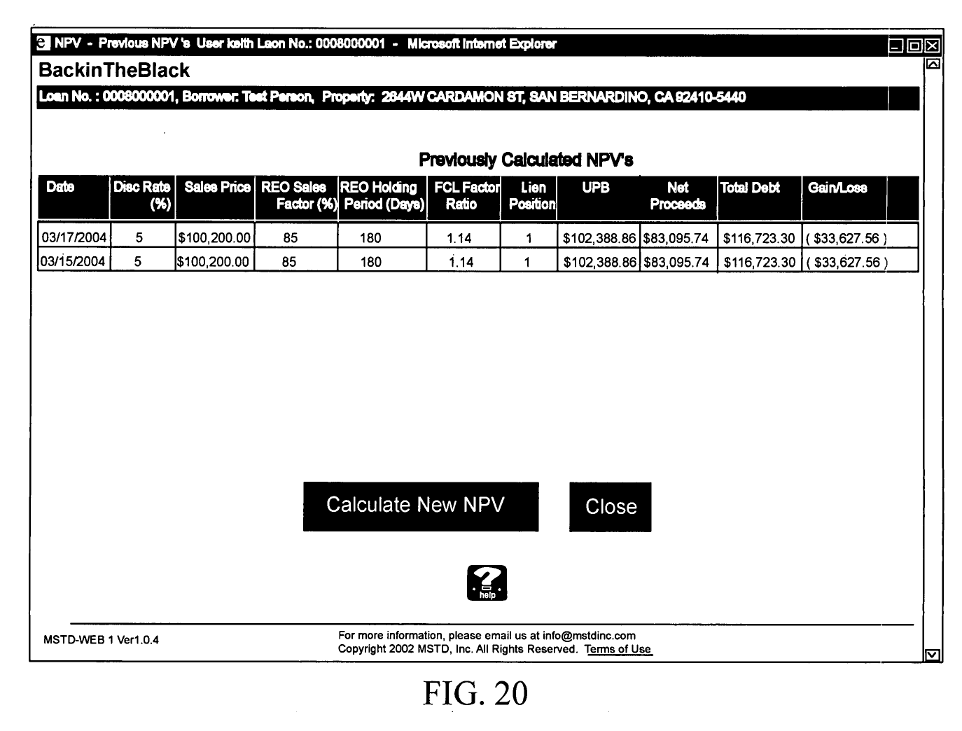

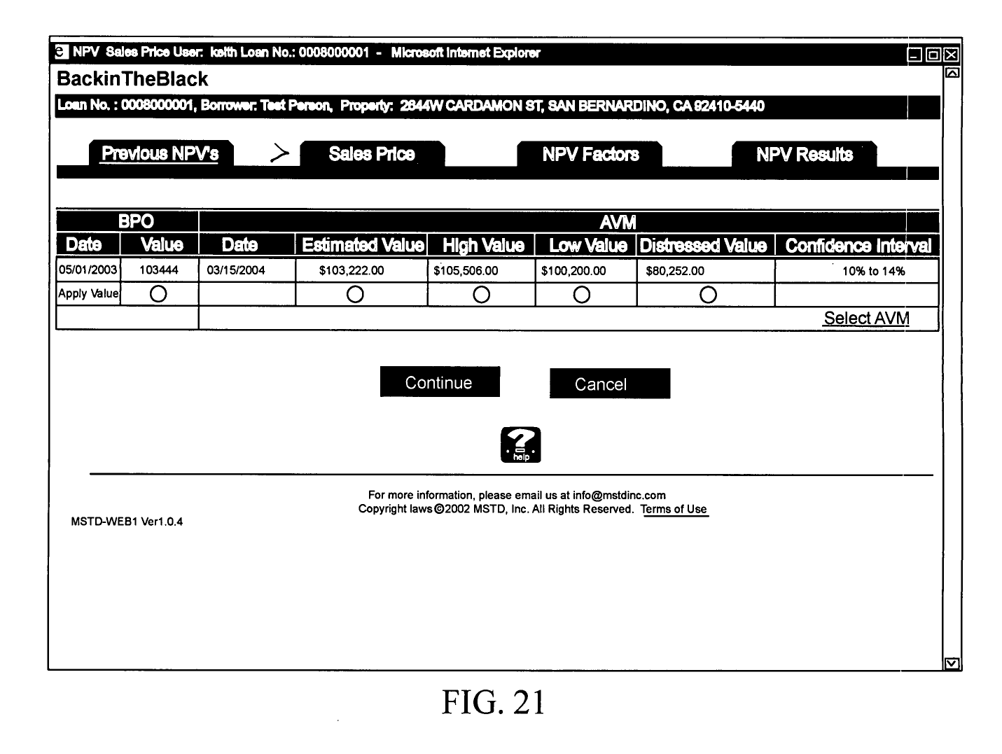

Previously calculated NPV's for a given loan are listed by clicking the previous NPV's tab in FIG. 18, which calls the Previous NPV screen of FIG. 20. Finally, the user may calculate a new NPV by clicking the Calculate New NPV button in FIG. 20. This calls the NPV Sales Price screen shown in FIG. 21, which allows the user to select the property's value. The user then chooses either a Broker's Price Opinion (BPO) or an Auto Valuation Model (AVM).

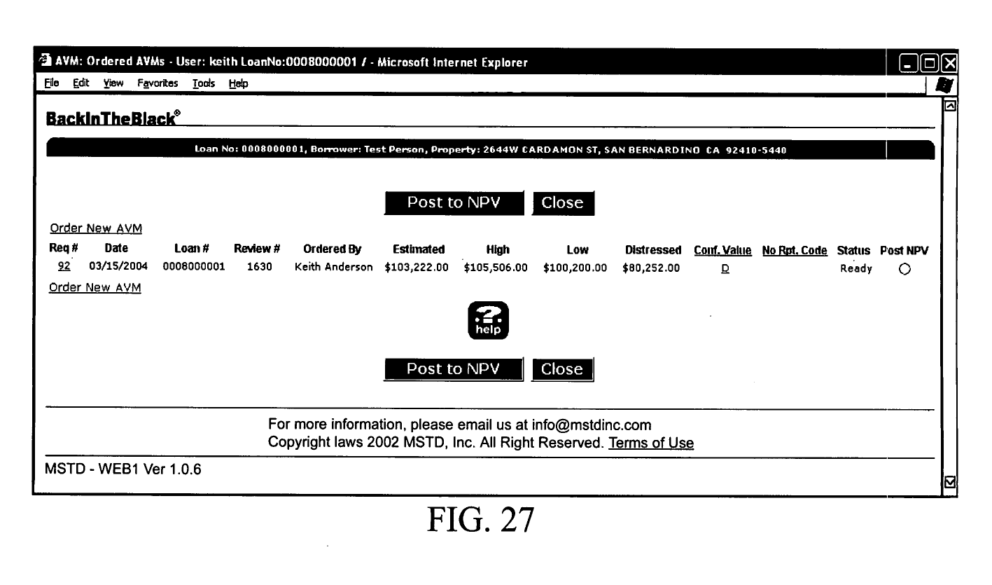

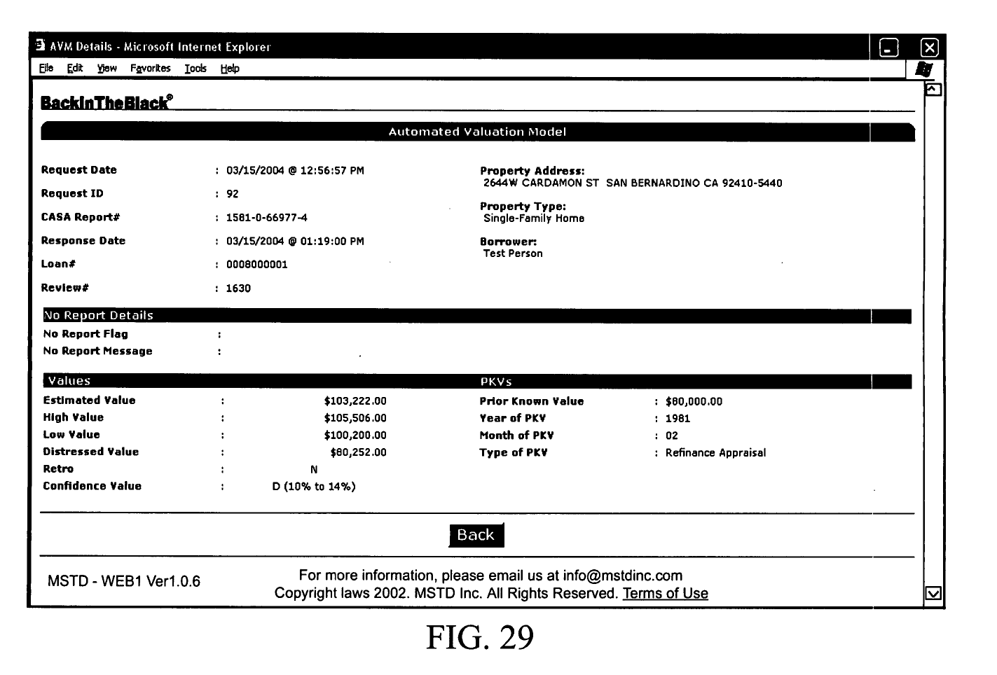

Property values may be integrated into the invention with co-operative development from a third-party or may be imported from the mortgage servicer's main system. FIG. 29 shows the values obtained from Case Shiller Weiss. AVMs may be ordered by clicking the Select AVM link at right in FIG. 21. This link calls the AVM History screen displaying all previously ordered AVMs (as shown in FIG. 27).

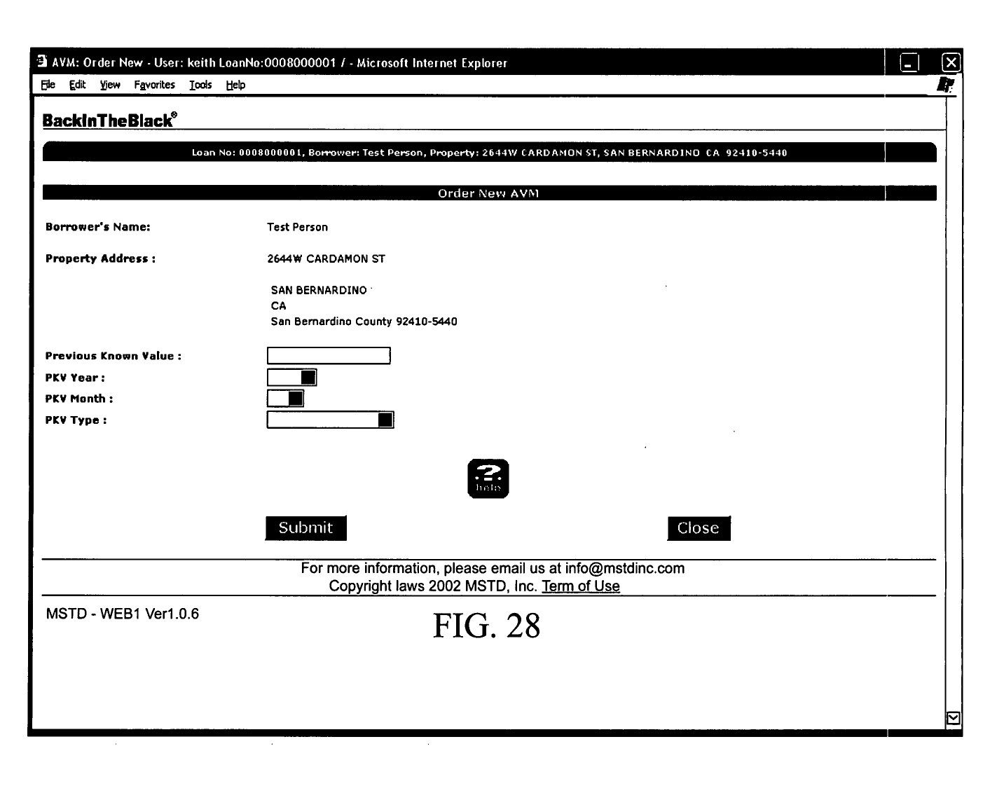

The user may choose an existing AVM value or order a new AVM. New AVMs are ordered by clicking the Order New AVM link shown in FIG. 27. This calls the Ordered New AVMs screen. The user may or may not enter information before clicking the submit button in FIG. 28.

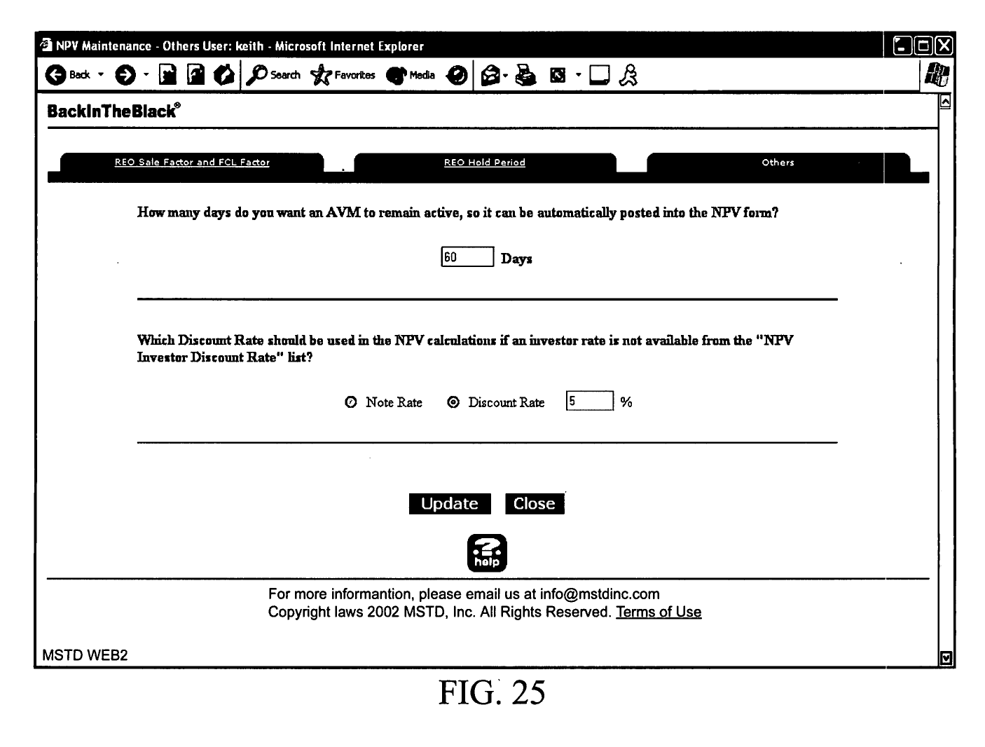

Upon clicking the submit button, the AVM is ordered in seconds and returns a range of statistically based values. The user may then post the values to the NPV Sales Price screen to be used in the NPV calculation. Depending on the manager settings shown in FIG. 25, a recent AVM may automatically appear in the NPV Sales price screen.

While on the NPV Sale Price screen, the user may select the appropriate property value by clicking its radio button and then clicking the Continue button shown in FIG. 21.

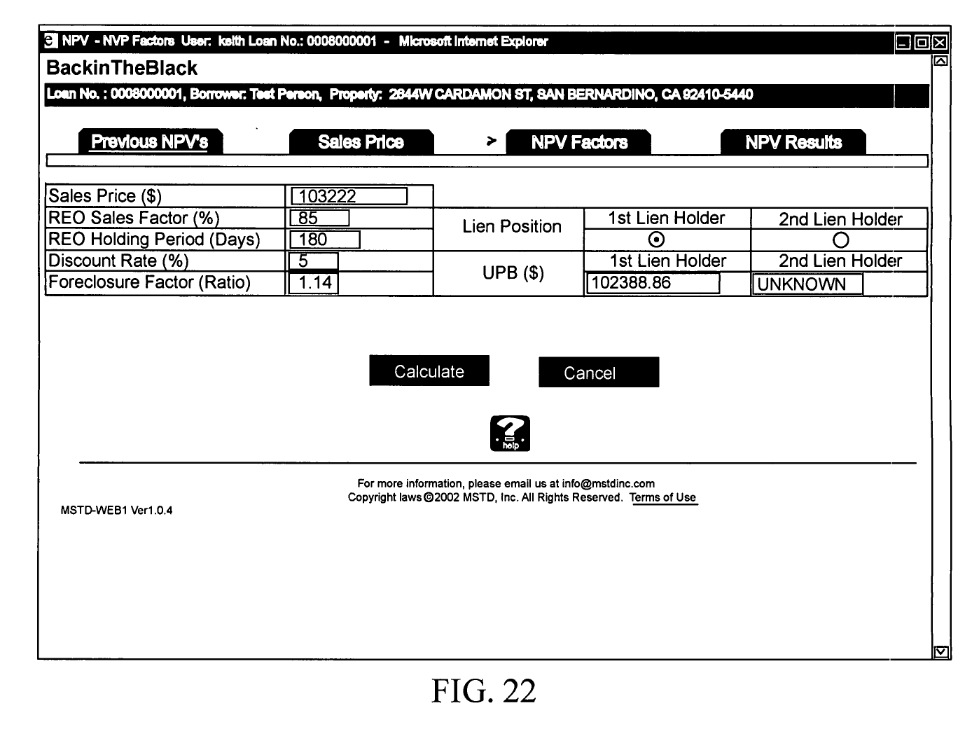

This action in turn calls the NPV Factors screen shown in FIG. 22. The screen allows the user to amend the previously selected property value or manually enter a property value if one was not selected from the NPV Sales Price screen. This screen also allows the user to input the following described values for the NPV calculation:

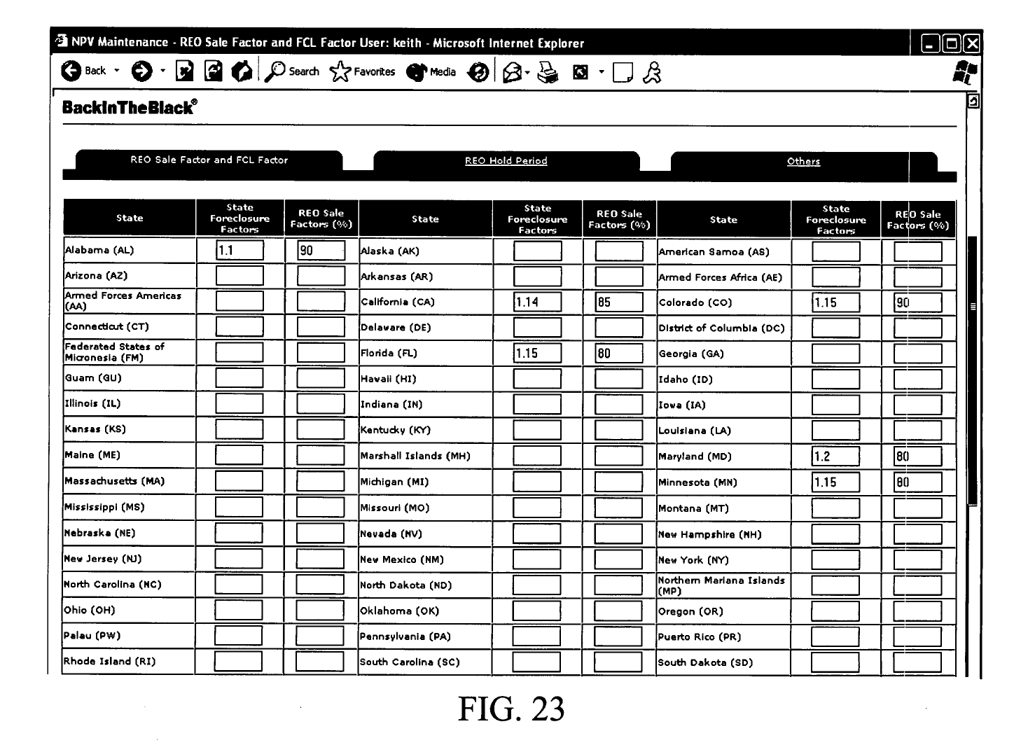

REO Sales Factor—If available, the REO Sales Factor is derived from a state specific table maintained by the Manager, shown in FIG. 23. This amount is the percentage of the Sale Price remaining, after all costs have been deducted from the REO Sale.

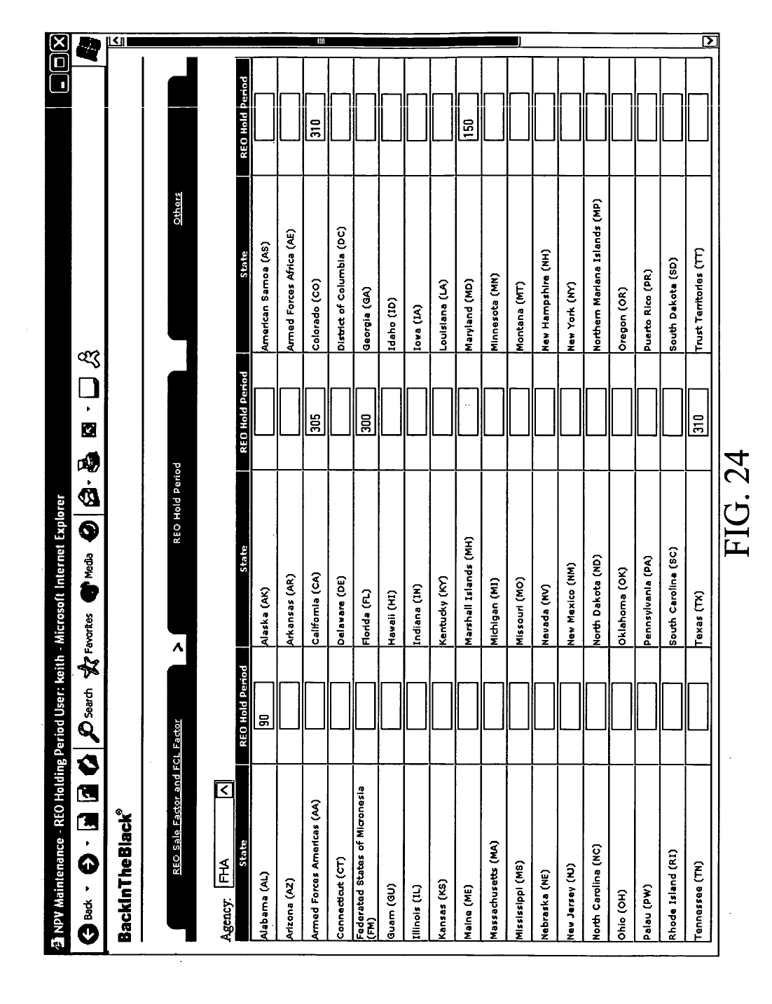

REO Holding Period—If available, the REO Holding Period is derived from a state and lender specific table maintained by the Manager in FIG. 24. This is the number of days between taking possession of the property at the FCL Sale and selling it at the REO Sale.

Discount Rate—The Manager will have the option to select between the Note Rate of the loan and a manually entered rate. The final comparison of the NPV calculation involves the Net Proceeds from the REO Sale and Total Debt@ FCL. Based on the Time Value of Money, BITB uses the Discount Rate to discount the Net Proceeds from the REO back to FCL Sale so it can be compared with the Total Debt@ FCL Sale in the same time frame.

Foreclosure Factor—If available, the Foreclosure Factor is derived from a state specific table maintained by the Manager in FIG. 23. This is the ratio (multiplier) used to calculate the Total Debt at FCL Sale from the Unpaid Balance (UPB)@ Default. By multiplying the UPB by the FCL Factor, all costs associated with maintaining and processing the loan from Default to the FCL Sale is added to arrive at the Total Debt@ FCL Sale. The Total Debt is comprised of the unpaid principal balance, accumulated interest, foreclosure fees and costs, property taxes, hazard insurance premiums, etc. less any funds in escrow, insurance reimbursement proceeds and rental proceeds.

Lien Position—The user is required to choose between the two lien positions. This dictates the type of calculation used and the placement of the UPB. If the 1st Lien Holder position is chosen, the UPB from BITB's loan information screen (FIG. 4) will be entered into the 1st Lien Position, not requiring any manual input. If the 2nd Lien Position is chosen, the user must manually enter the 1st Lien Holder's UPB.

After all the factors and values are determined, the user may see the NPV results obtained by clicking the Calculate button shown in FIG. 22.

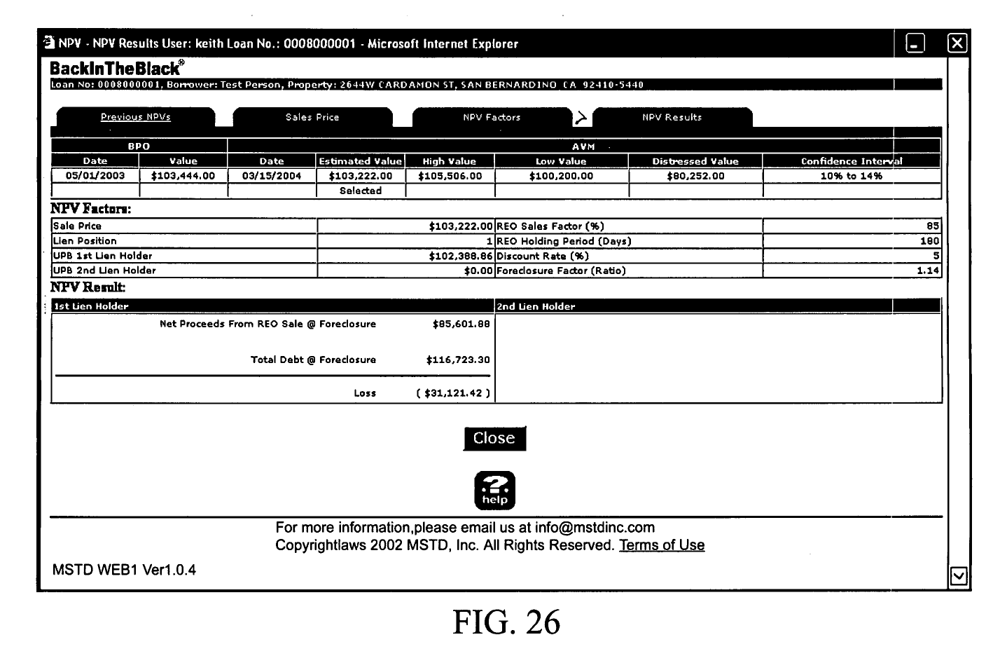

At the bottom of FIG. 26, the resulting NPV “Gain” or a “Loss” is displayed. This in turn determines the mortgage servicers equity position in a foreclosure situation.

### Collections Reports

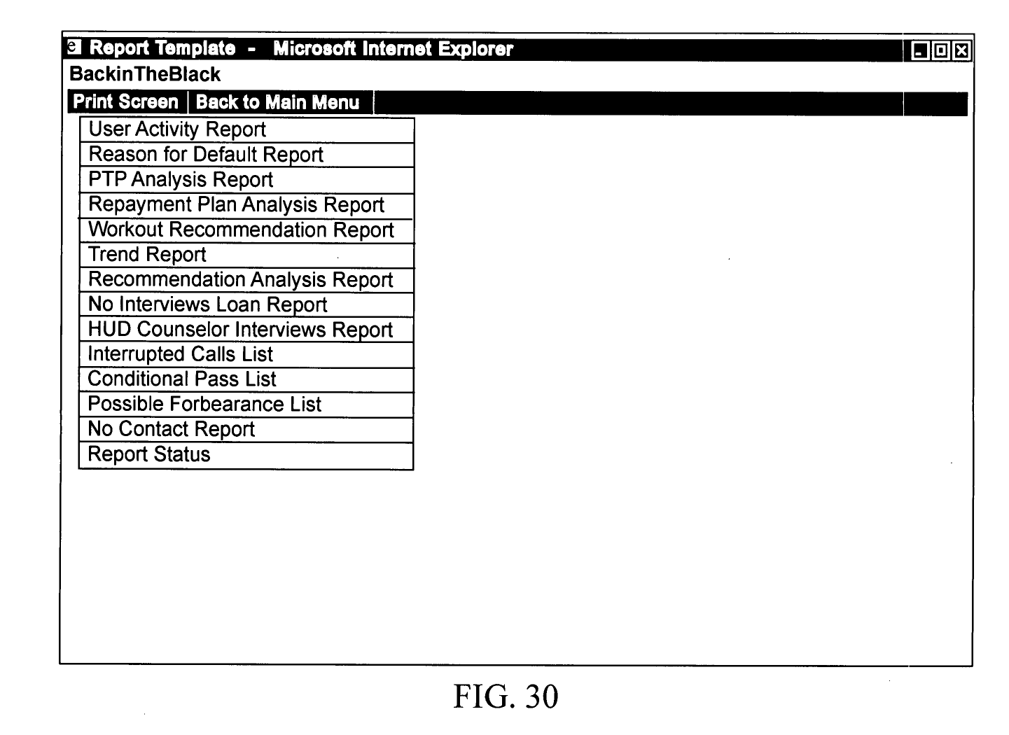

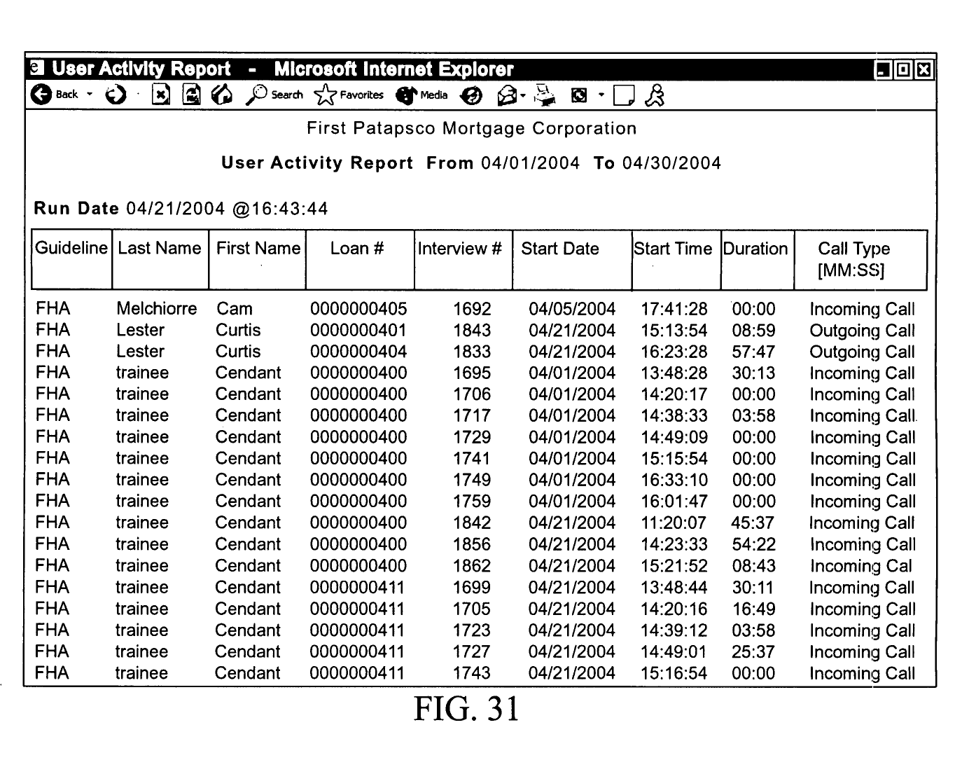

Subscribers also have available an array of standard reports, which can be printed or displayed from the report menu as shown in FIG. 30. The report menu may be accessed by clicking the Reports link from the main screen (FIG. 4). These reports comprise a series of built-in production and performance records, which can assist management in assessing user behavior. For example, the User Activity Report of FIG. 31, notes the duration of each borrower-counseling session conducted by a specific collector, and is an excellent tool for use in refining interview skills.

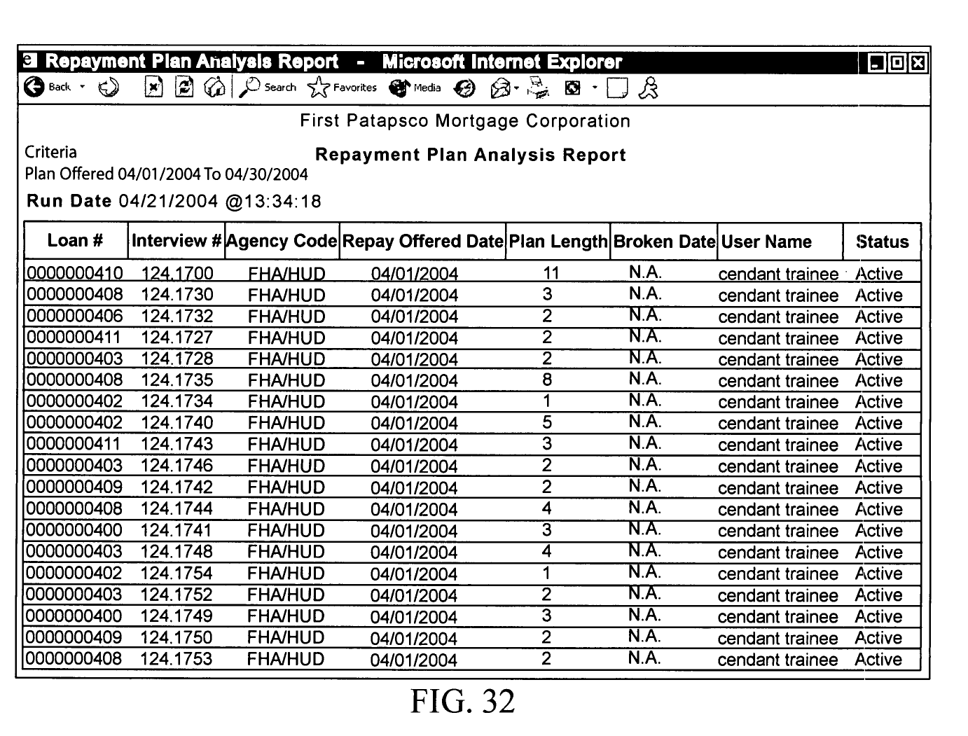

Repayment plan and promise to pay analysis reports not only show managers quantitative results as to plans or promises offered, but also actively measure the status and success rates of plans and promises as shown in the Repayment Plan Analysis Report of FIG. 32. If a plan is broken, this information will be displayed in the report.

Other reports provide low-level and summary information from the database, and are freely available anytime.

### Global Default System (GDS)

The present system incorporates a unique Global Default System (“GDS”) that presents a user with a global loan-servicing view, so that the major aspects of a loan in a default may be reviewed on one screen as shown at FIG. 33. The GDS is navigable by tabs (Overview, Loss Mitigation, Foreclosure, Bankruptcy, Audit View) that appear across the top of a page. Selecting the first tab Overview displays all steps and dates for both scheduled and completed activities related to a loan. A drop-down filter menu entitled “View” at the top of the screen Oust under the Overview tab), enables users to filter events by the following criteria, in any combination (FIG. 33).

Track Zone:—Choose Among Zones to Track:

All

Loss Mitigation

Foreclosure

Bankruptcy

Events:—Choose Among Types of Event to Track:

All

Scheduled

Completed

Stages:—Choose Among Types of Steps to Track:

All

Major Only

The results as filtered are shown below, including all the major reminders, deadlines and other events (past and future) for the loan in default. An “S” appearing within an activity field before an event date signifies that the event is scheduled. A “C” appearing within an activity field before an event date signifies that an event is complete. The color green within an activity field indicates that an event is both on schedule, and can still be completed within the allotted time. The color yellow within an activity field indicates that an event's completion date is imminent. The color red within an activity field indicates that an event is past due or late. An activity field will stay red if its event is completed late.

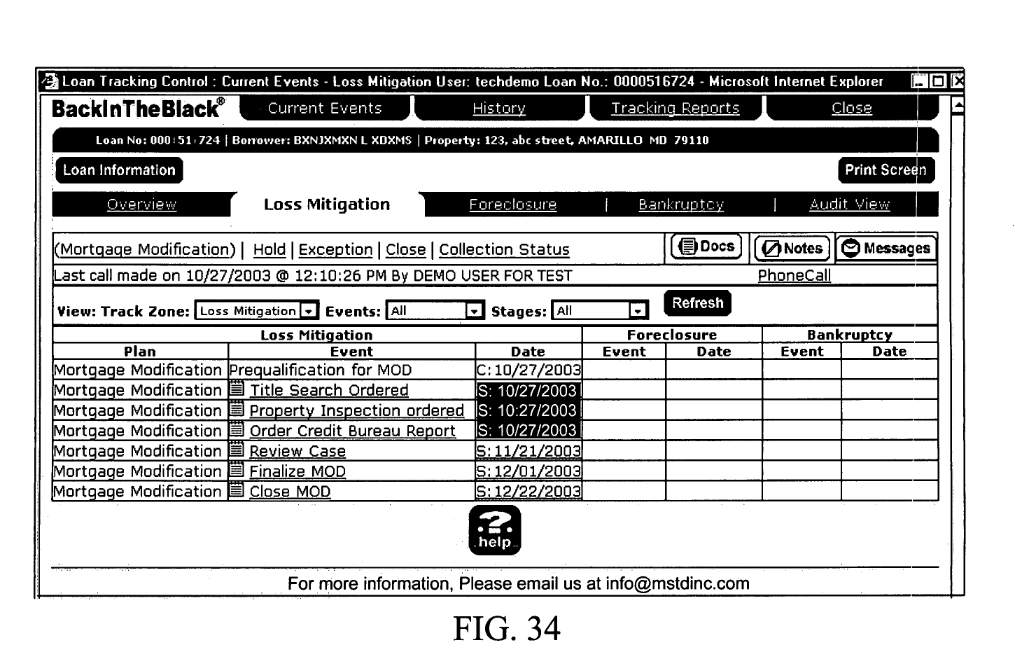

By clicking the Loss Mitigation tab of FIG. 33 a Global Default System component Loss Mitigation track zone as shown in FIG. 34 is displayed. This allows users to complete steps pertaining to collections and loss mitigation, and leave accompanying remarks. Allowable steps, and their logic, are user-predefined by a subscriber. As in FIG. 33, a drop-down-filter menu, at the top of the screen of FIG. 34 allows users to display events by following the criteria described earlier, in the Overview Screen. Remarks pertaining to a scheduled event may be entered by clicking the Note Pad icon at left, which allows users to enter notes relating to the specific track zone. All entered Remarks are dated and serve to relate forward progress to steps taken.

Completion of a step is accomplished by clicking on an Event hyperlink and completing the required information. After a step is completed, it will appear with a “C” in front of the date, with the hyperlink removed from the step text.

Incoming and outgoing calls can be recorded by clicking the “Phone Call” link (beneath the Notes icon) in the Collections track zone.

Clicking the Messages button or link depending upon the track zone allows users to view, receive, and send email messages to and from outside parties, such as foreclosure attorneys.

### Mortgage Modification Tracking Process

After a borrower prequalifies for a loss mitigation alternative in the invention's collection area and is a likely candidate for a workout, a hard copy workout package is generated automatically for sending by mail. On return of the completed package, activity by the loss mitigation department is tracked in the above-described GDS. The GDS simultaneously tracks all activity and provides the tools needed (ie: workout calculators and document creation) to complete workout options.

Customized tracking templates for each loss mitigation workout are built to meet the servicer's process flow upon GDS implementation. These templates allow employees in the loss mitigation department (as well as in other mortgage servicing departments) to stay abreast of each other's activities in real-time. As tracking events are updated, all parties with the proper authority and access level, can determine at which stage a loan is in the loss mitigation process.

Workout options such as mortgage modifications may be tracked as soon as a collection user clicks the hyperlinked option's name on the eligibility screen (FIG. 13) in the invention's collection interview. Typically, when a hard copy of the workout package is returned by mail, the loss mitigation department can begin performing various tasks prompted by the invention's loss mitigation track zone template shown in FIG. 34.

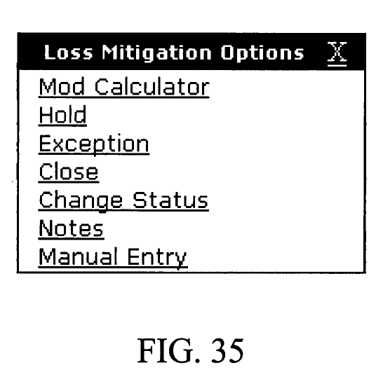

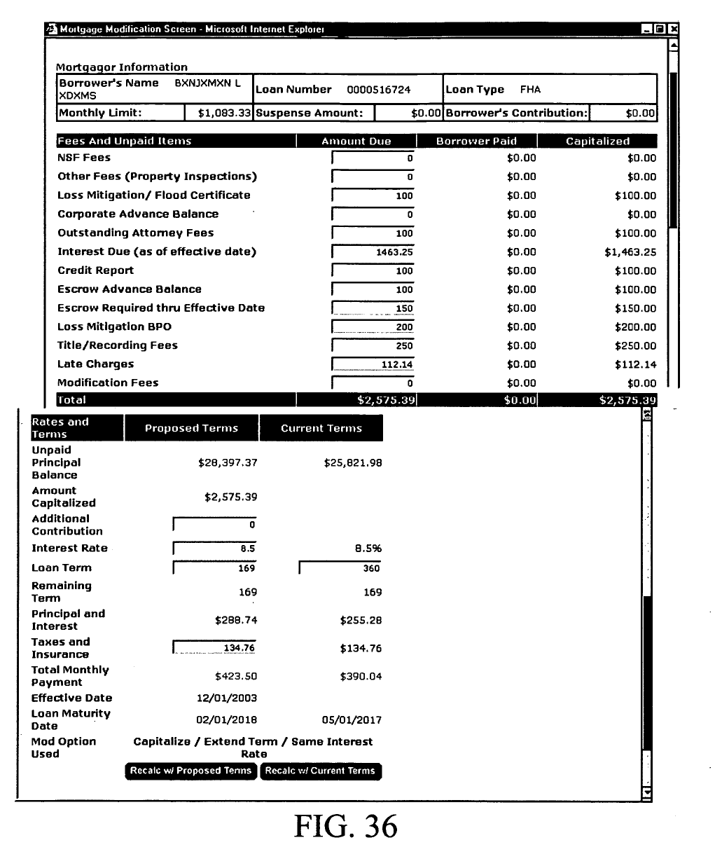

In the example of a mortgage modification, all tools related to the workout are accessible by clicking the mortgage modification link (or other loss mitigation option's link), located to the left of the Mitigation track zone of FIG. 34. This calls a layered menu as seen at FIG. 35. Upon clicking Mod Calculator the user may calculate and adjust the terms of the modification plan via the interface of FIG. 36.

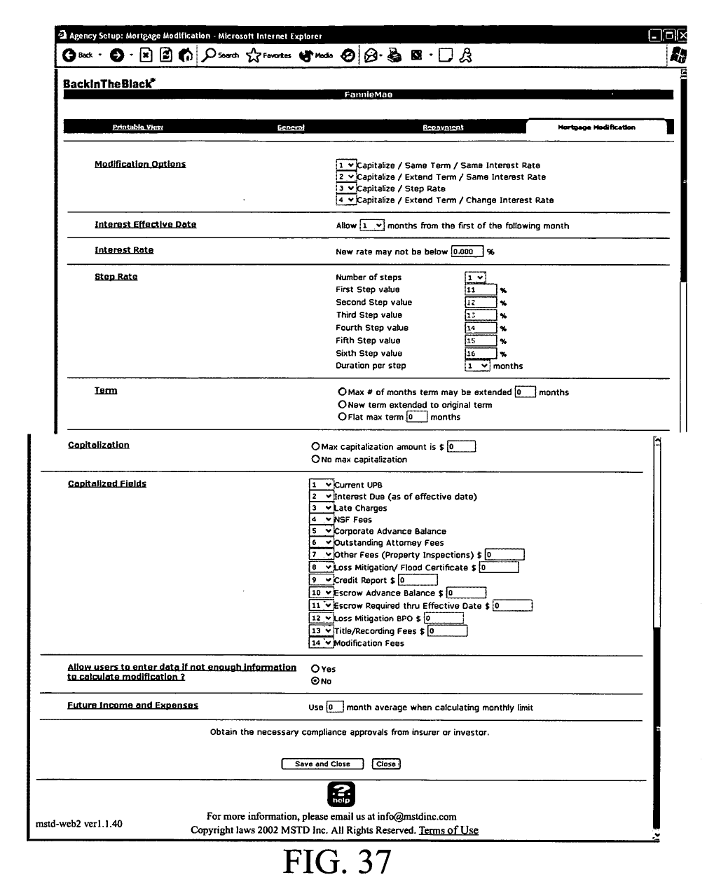

FIG. 37 shows the customizable modification setup table accessed by logging in as a Manager through a Manager Menu. The setup table allows all parameter settings involved in a mortgage modification to be specified in-house, at a servicer's location. This allows the loan servicer to place constraints on their loan counselors. Each loan type has a specific modification setup table. Along with determining interest rate, duration, and capitalization amount of the loan to be modified, users can select the fields to be capitalized, the order in which fields are paid off, and the order in which modification calculations are performed.

The flexible features of the table-driven, loan specific, modification calculator are demonstrated by the following four iterations, which a user explores when determining the most appropriate loan workout:

### Method of Calculation

1. Capitalize; Same Terms & Interest Rate

2. Capitalize; Extend Terms, Same Interest Rate

3. Capitalize; Step Rate

4. Capitalize; Extend Terms, Change Interest Rate

The goal of every loan Modification Option is to find a payment amount that is less than or equal to a borrower's Monthly Limit, or what the borrower can afford. To find this payment amount, several factors must be considered. The following steps are taken when calculating a modification:

1. Obtain and display mortgage modification calculator field values.

2. Obtain the Proposed UPB: Current UPB+Amount Capitalized.

3. Subtract “Taxes and Insurance” (Proposed Terms) value from Monthly Limit to derive “New Monthly Limit”.

4. Obtain order of Modification Options, per Modification Setup table.

5. Using the Proposed UPB, follow the procedure detailed in the first Modification Option to find a “Principal and Interest” payment that is less than or equal to the new Monthly Limit. If first Modification Option cannot create a payment less than or equal to the “New Monthly Limit”, use the next Modification Option.

6. When a “Principal and Interest” payment is found that is less than or equal to the “New Monthly Limit”, display the in the “Proposed Terms” column the values used in the calculation for the following fields: Interest Rate, Loan Term, Principal and Interest, Total Monthly Payment, and Mod Option Used.

1. Capitalize; Same Terms & Interest Rate

1. Capitalize all fees per the Modification Setup for a specific loan type.

2. With the new (Proposed) UPB, calculate P&I payment using Current Remaining Term and Current Interest Rate.

2. Capitalize; Extend Terms, Same Interest Rate

1. Capitalize all fees per the Modification Setup for a specific loan type.

2. With the new (Proposed) UPB, calculate P&I payment using Current Interest Rate and Current Remaining Term.

3. If P&I Payment>New Monthly Limit, add 1 to Term value.

4. Recalculate P&I payment using new Term value.

5. Repeat step 3 until P&I</=New Monthly Limit. Term may be extended only to the limit set in the Modification Setup table

3. Capitalize; Step Rate

1. Capitalize all fees per the Modification Setup for a specific loan type.

2. With the new (Proposed) UPB, calculate P&I payment using Current Remaining Term and Current Interest Rate.

3. If P&I payment>New Monthly Limit, subtract amount found in the “First Step Value=______%” field (Modification Setup Table) from Current Interest Rate.

4. Recalculate P&I payment amount using new Interest Rate. Increase Interest Rate one “step” after the duration, as specified in the “Duration=______months” value.

5. If P&I payment>New Monthly Limit and “Number of Steps” value (from Modification Setup table)>1, subtract amount found in “Second Step Value=______% field (Modification Setup Table) from last Interest Rate used. Repeat step 4 and continue lowering interest rate by steps, as the Modification Setup table permits.

6. If the last allowed step cannot produce a P&I payment less than or equal to New Monthly Limit, extend Term value by 1.

7. Recalculate P&I payment using new Term value and the lowest Interest Rate allowed.

8. Repeat step 7 until P&I</=New Monthly Limit. The Tern may be extended only to the limit set in the Modification Setup table.

4. Capitalize; Extend Terms, Change Interest Rate

1. Capitalize all fees per the Modification Setup for a specific loan type.

2. With the new (Proposed) UPB, calculate P&I payment using Current Interest Rate and Current Remaining Term.

3. If P&I Payment>New Monthly Limit, add 1 to Term value.

4. Recalculate the P&I payment using the new Term value.

5. Repeat step 3 until P&I</=New Monthly Limit.

6. The Term may be extended only to the limit set in the Modification Setup table.

7. If the Term has been extended to the max-allowed value (per Modification Setup table), subtract 0.125% from interest rate.

8. Recalculate P&I payment using max-allowed Term and new Interest Rate value.

Repeat step 7 until P&I</=New Monthly Limit. The Interest Rate may be lowered only to the limit set in the Modification Setup table (Interest Rate section).

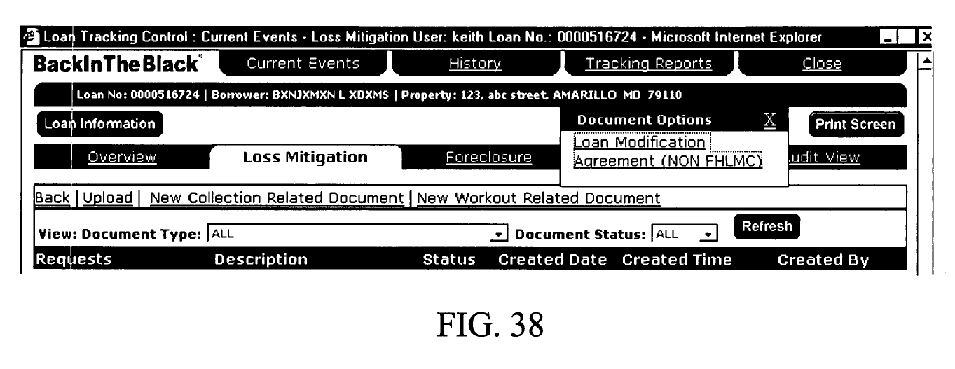

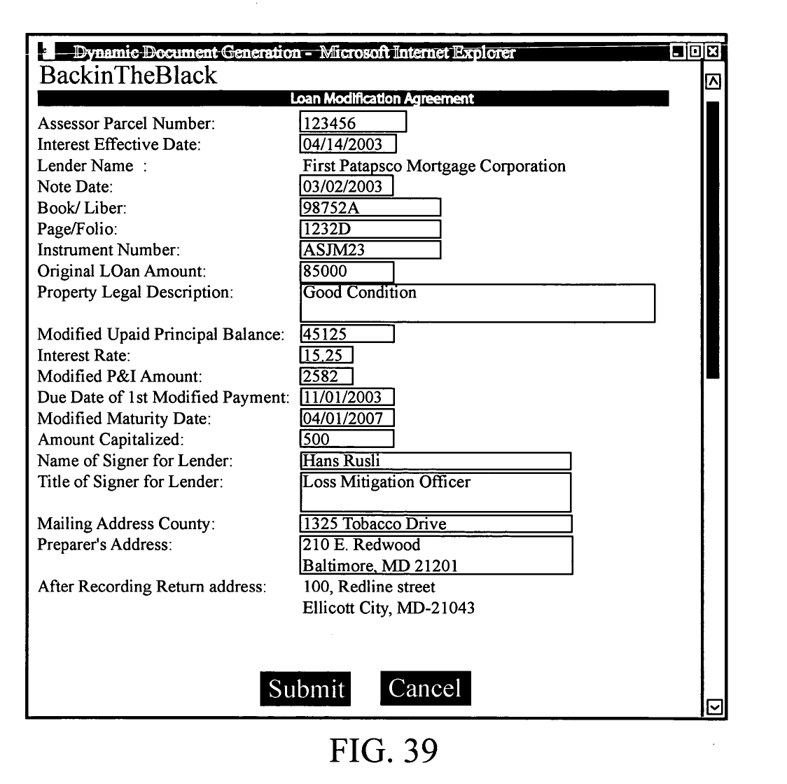

After the modification plan has been finalized, the loss mitigation user may prepare modification documents by clicking the Docs button (FIG. 34). The document options layered menu, allows the user to select the modification type i.e. FHLMC (Freddie Mac) or non-FHLMC (FIG. 38). After clicking the modification document type, a loan modification form is presented (FIG. 39) by which the user may enter all the information into the system to prepare the modification documents. Any information already in the invention's database, such as loan information and calculation information, will pre-populate into these fields. This information may be amended if pre-populated. After this form is complete, the user then clicks the submit button (FIG. 39 bottom).

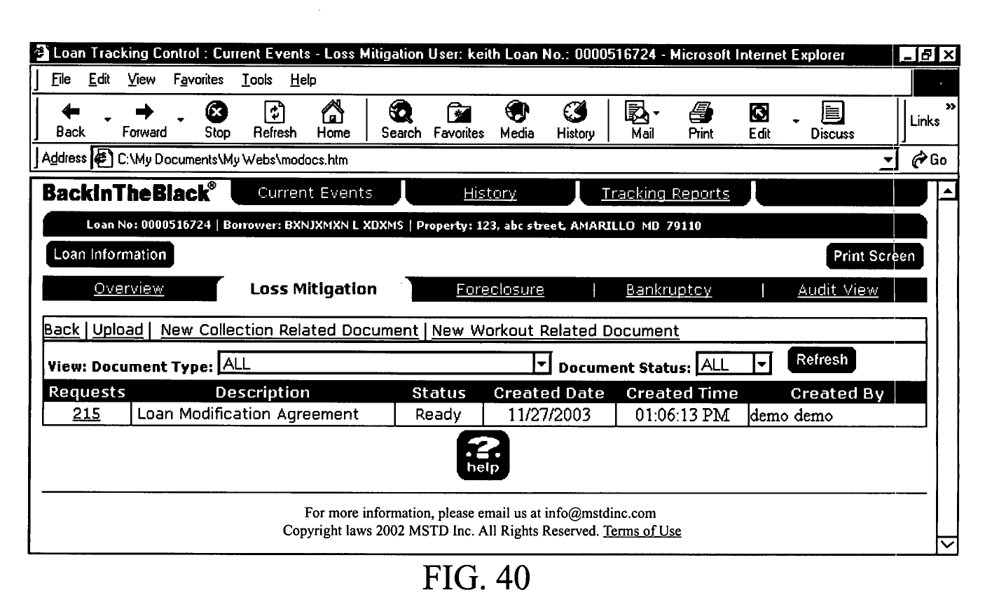

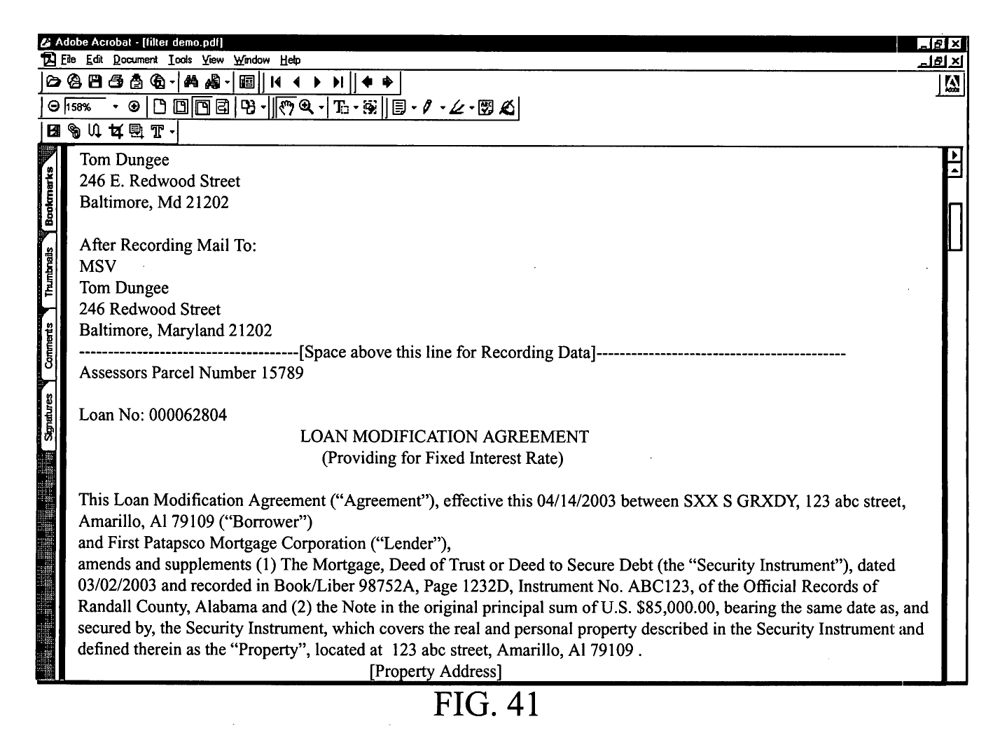

Following the submission of the modification document information, the modification document is created. When finished processing, the document screen displays the word “ready” in the status column, the ordered document may then be accessed. The user can click the documents hyperlinked request number (FIG. 40) to open the modification document in PDF format (FIG. 41). The invention automatically creates the modification document to meet state format requirements and investor specifications. At this point, the mod document may be printed to hard copy, saved or e-mailed.

To complete the rest of the loan modification processes, the user can continue to follow the sequence of events present in the loss mitigation track zone (FIG. 34).

### Pre Sale Calculator

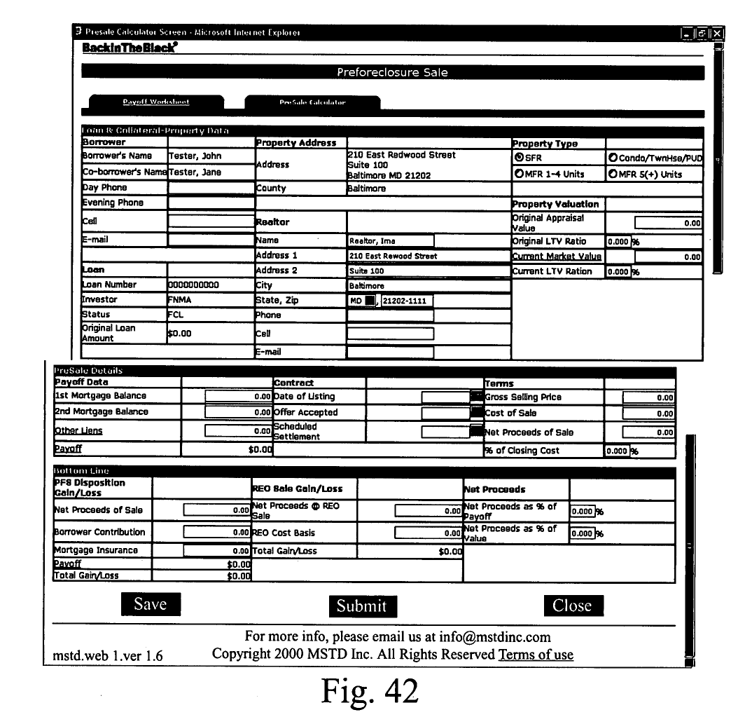

FIG. 42 illustrates the Pre Sale calculator, which is accessed by clicking the Pre foreclosure Sale link from the Calculations menu (FIG. 14). The Pre Sale calculator performs calculations for workouts in which the borrower relinquishes the property. These include preforeclosure sale, deed in lieu of foreclosure and real estate owned (REO) sale. The calculator pulls information present in the system database and allows the user to input or amend data used in the calculation. The calculator integrates information from all parties involved in this process, such as the mortgage servicer, borrower, mortgage insurer and real estate agent, thereby integrating all parties into one unified process. Furthermore, the Pre Sale calculator calculates the economic consequences of the servicer's actions and facilitates an accurate decision in a short period of time.

### Foreclosure Referral & Tracking Process

Since the invention is an open platform of communication, with permission from the mortgage servicer, foreclosure attorneys handling servicer accounts may login to GDS and track the activities of loans in foreclosure. Attorney users log into a separate entry point or portal to access the system as will be described. In essence, GDS allows the servicer and attorney to synchronize their activity in real-time, thus, completing foreclosure activity faster and more efficiently, while meeting investor compliance.

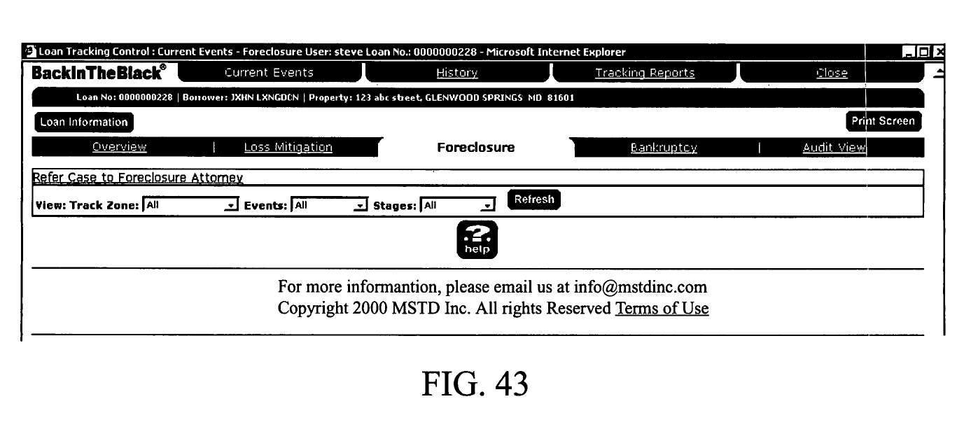

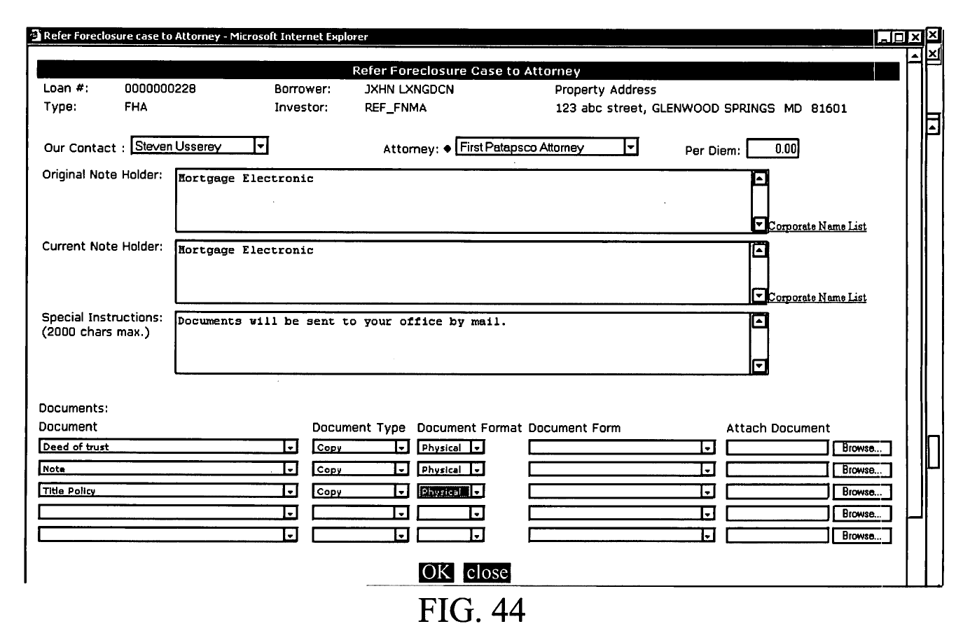

The mortgage servicer initiates the foreclosure process. The user begins by searching for the loan and navigating to the foreclosure track zone of GDS. Once in the foreclosure track zone, the user clicks the Refer Case to Foreclosure Attorney link (FIG. 43). After doing so, a referral entry screen appears as seen in FIG. 44. The user may enter information pertaining to the foreclosure and indicate which documents are to accompany the referral. The system supports transmission and storage of electronic documents. If documents are sent by postal mail in hard copy, this may be documented in the referral entry screen.

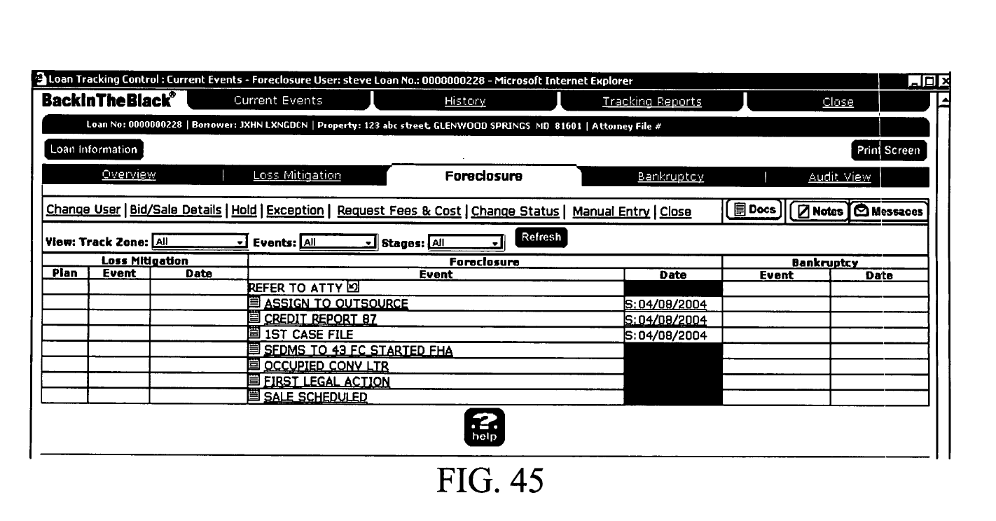

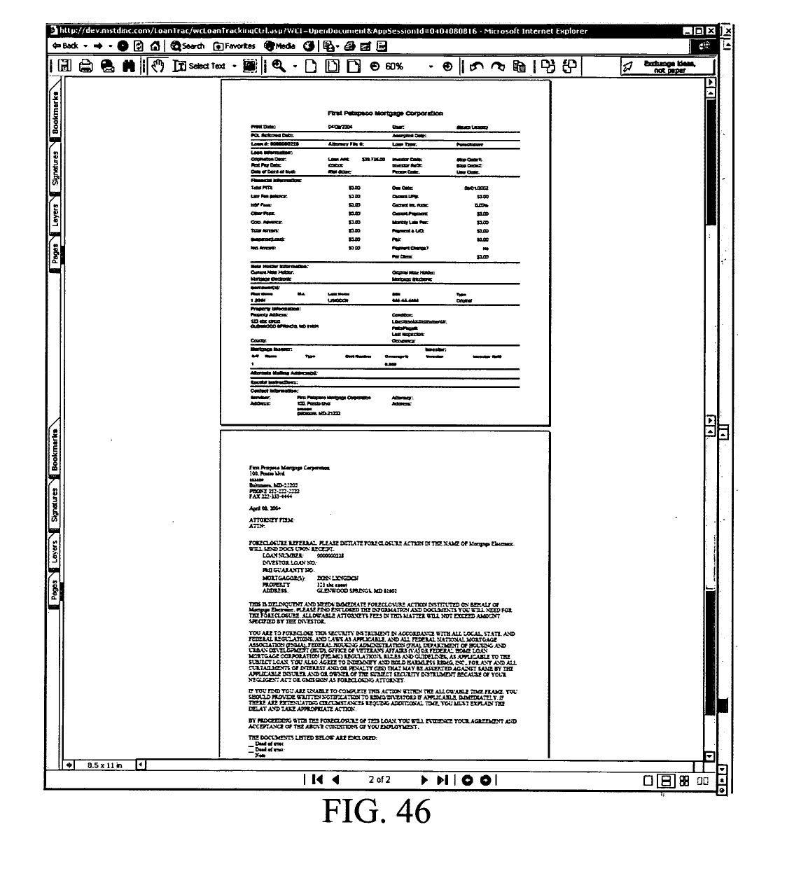

After completing the referral entry screen, the user clicks the OK button (FIG. 44). Clicking the OK button, will load the foreclose template of events into the foreclosure track zone as seen in FIG. 45. Note that the foreclosure templates are created by the servicer upon implementation and are set up by state to meet state laws, time frames and requirements. Simultaneously, the system will automatically send a message to the foreclosure attorney indicating that the servicer has sent a new foreclosure to be processed. Also, the system automatically produces a foreclosure referral cover letter that can be accessed by clicking the Referral Package link in the foreclosure track zone. The referral information and cover letter are displayed as a graphic as shown in FIG. 46 and may be printed and sent along with the hard copy referral package to the attorney.

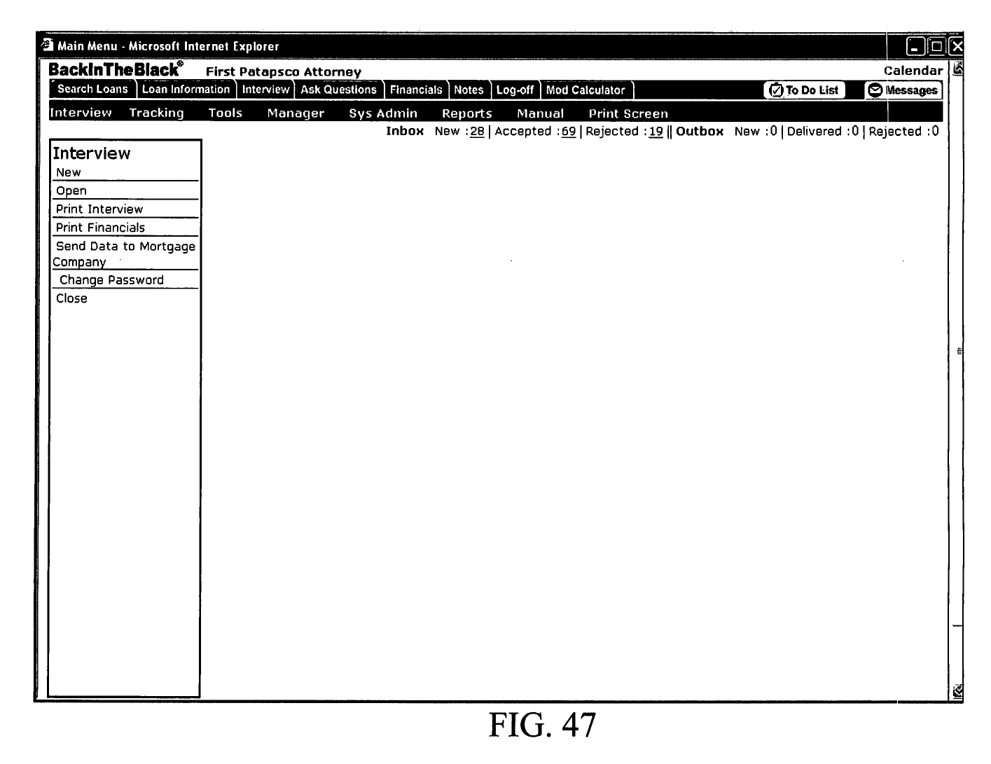

Attorney users log into a separate entry point or portal to access the system. FIG. 47 is a screen print of the attorney portal, by which the attorney is granted the ability to accept referrals, update tracking events and communicate via internal messaging with the mortgage servicer.

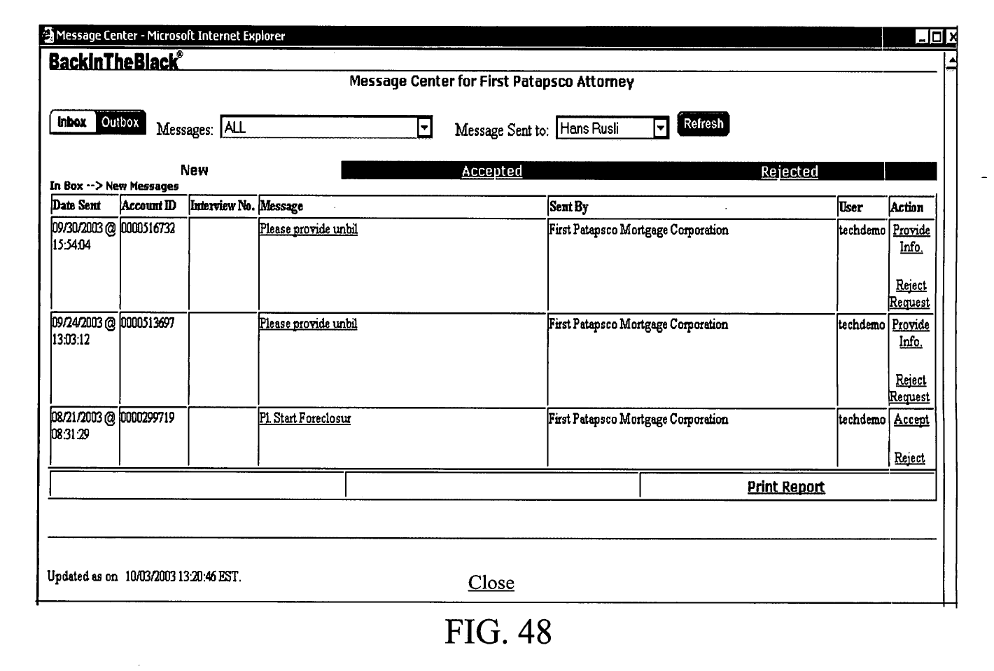

Upon logging into the Attorney portal (FIG. 47), the attorney utilizing GDS is notified of new messages that have arrived from the mortgage servicer (See Inbox New Messages). The user clicks the hyper linked number next to “Inbox New” on the main page, which leads to a list of new Inbox messages as shown in FIG. 48. While in the Inbox New folder, the user can identify new foreclosure referrals by the message title: “PI. Start Foreclosure” (as shown in the third message entry down). The user can click this message title to review the cover letter and referral information (FIG. 46). If the referral is to be accepted by the law firm, the user clicks the Accept hyperlink.

After reviewing and accepting the referral, the attorney user may search and find the loan and continue tracking the events that the firm is responsible for completing in the foreclosure track zone of GDS. Upon updating these steps, the mortgage servicer can see and measure the activity completed by the foreclosure attorney through the servicer's GDS foreclosure track zone and reporting capabilities.

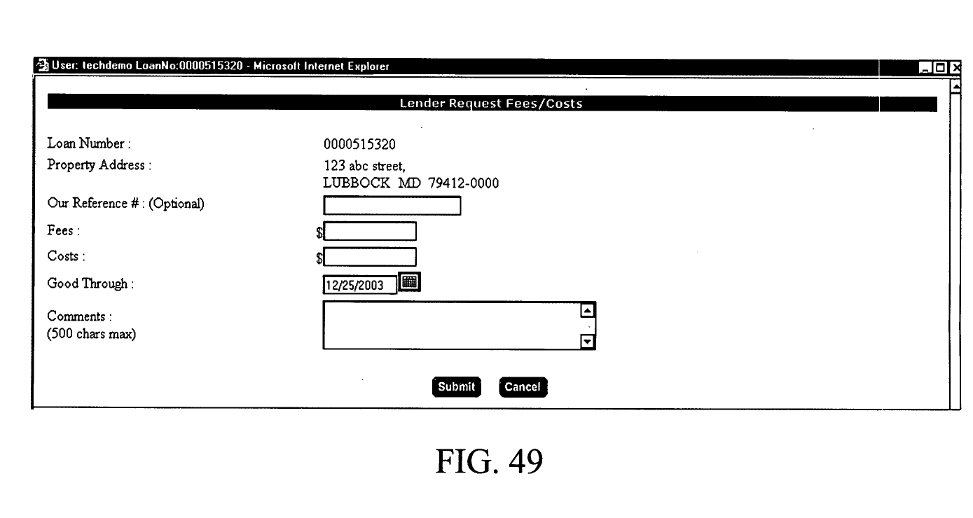

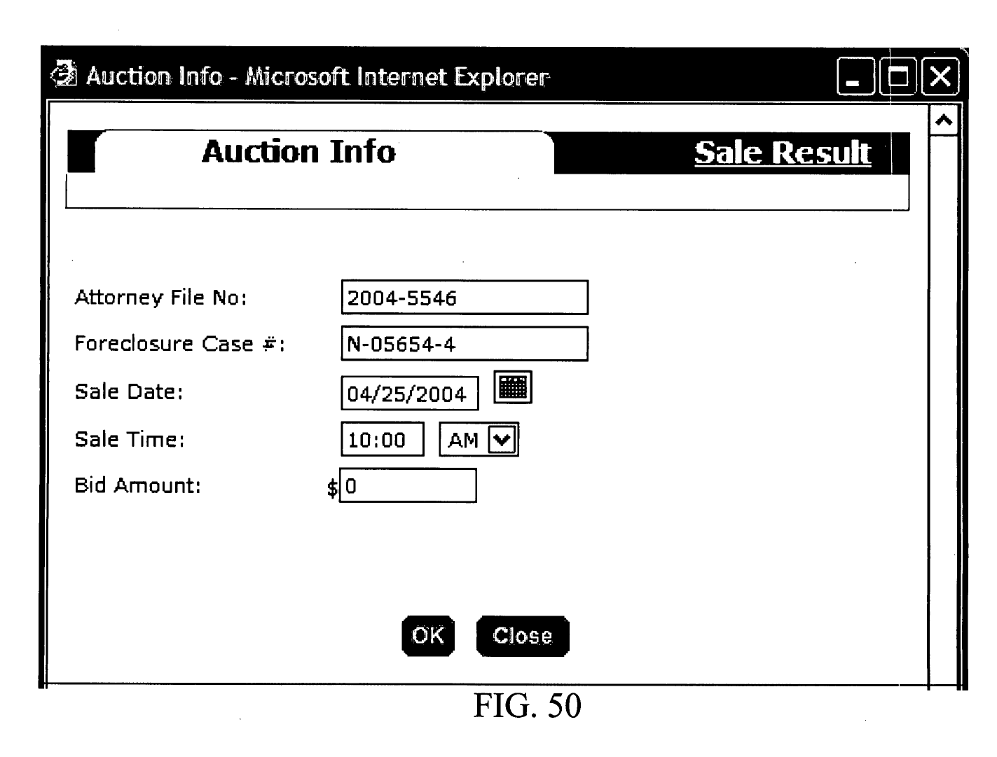

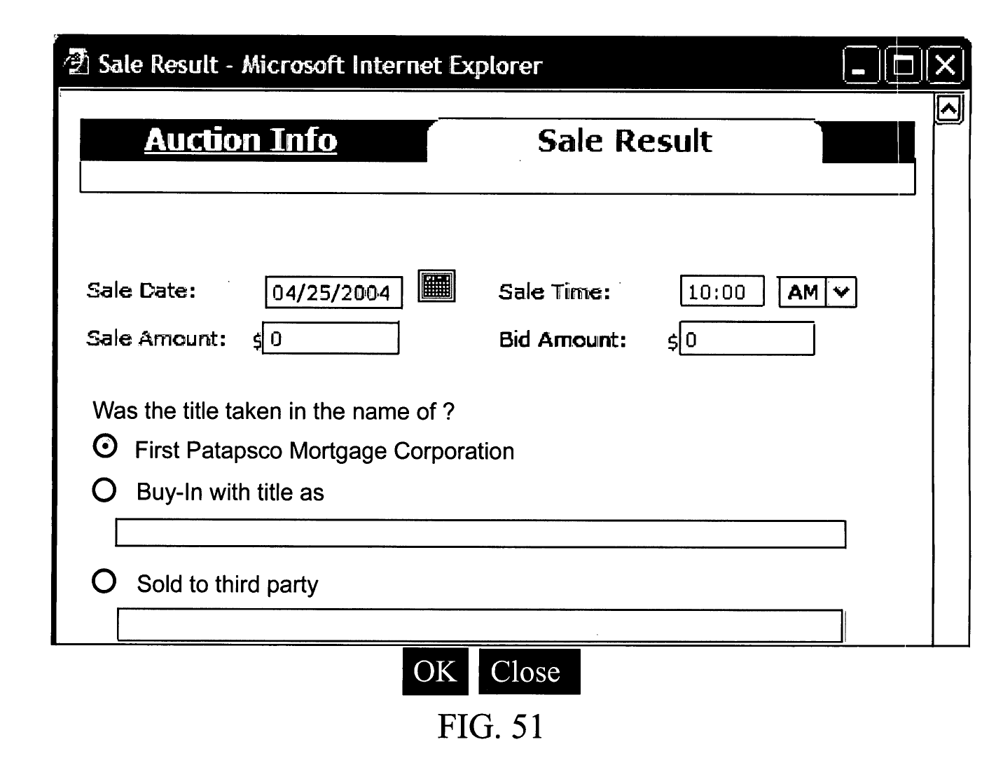

Other interaction between the servicer and foreclosure attorney such as requesting foreclosure fees and costs (FIG. 49) and providing foreclosure auction information (FIG. 50) and sale results (FIG. 51) can also be accomplished in real-time. These facilities are accessed by clicking the appropriate links in the attorney or mortgage servicer portal Foreclosure track zones of GDS

### Bankruptcy Tracking Process

GDS also provides the facility for mortgage servicers and bankruptcy attorneys to share the same platform when tracking bankruptcies.

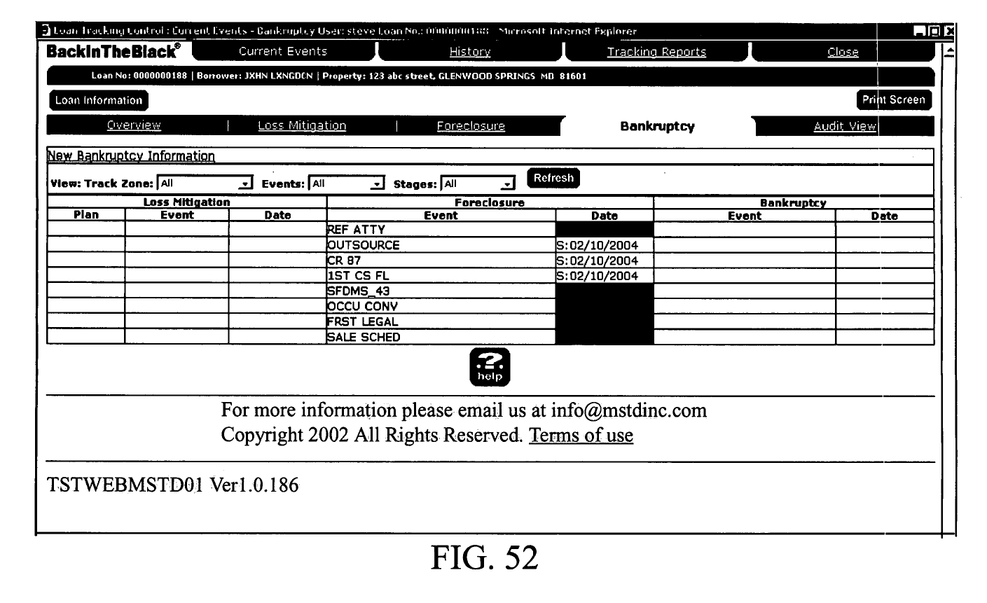

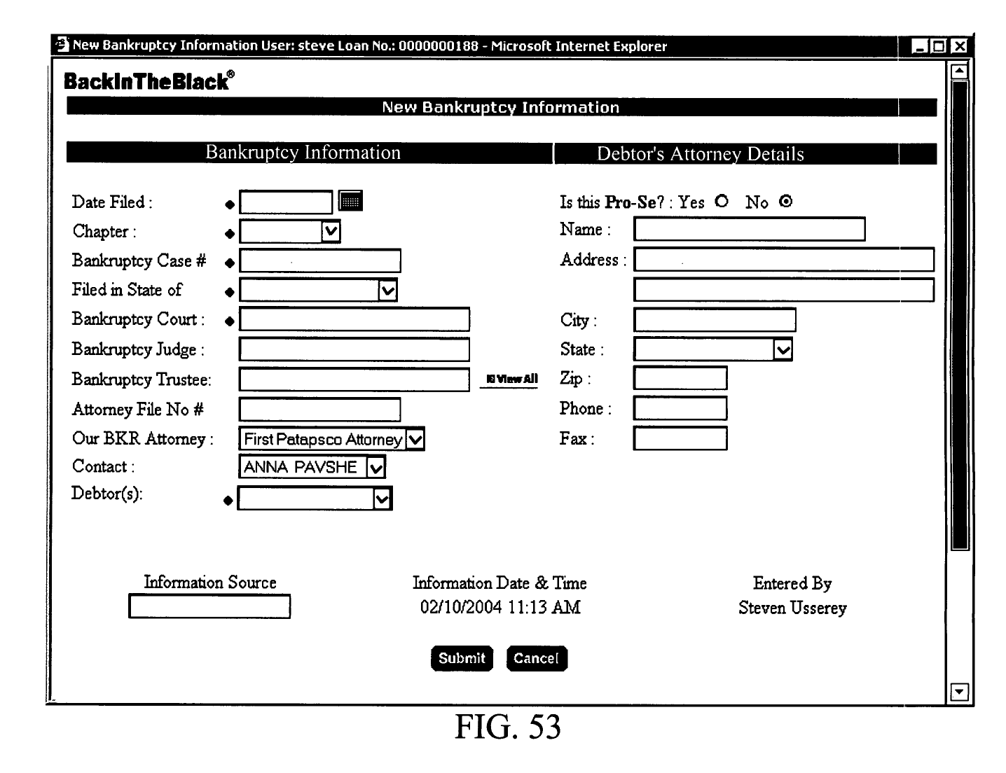

Bankruptcies may be initiated in GDS when the attorney or mortgage servicer clicks the Initiate New Bankruptcy link in the mortgage company or attorney portal Bankruptcy track zone shown in FIG. 52. Once the Bankruptcy information is entered and the user clicks submit (FIG. 53), event tracking by both of the aforementioned parties may begin.

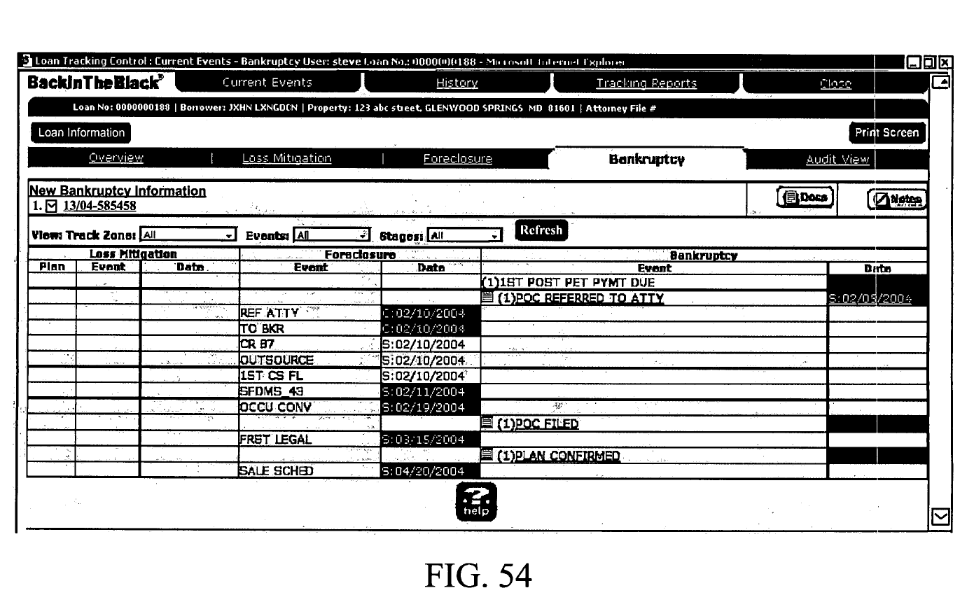

A unique complexity to the Bankruptcy process is that a borrower may file more than one bankruptcy concurrently. GDS handles this by tracking and providing tools specifically for each bankruptcy. Each new bankruptcy filing will receive a link at the top of the bankruptcy track zone and events related to each filing will appear in the tracking area with the corresponding number of the filing before them (FIG. 54).

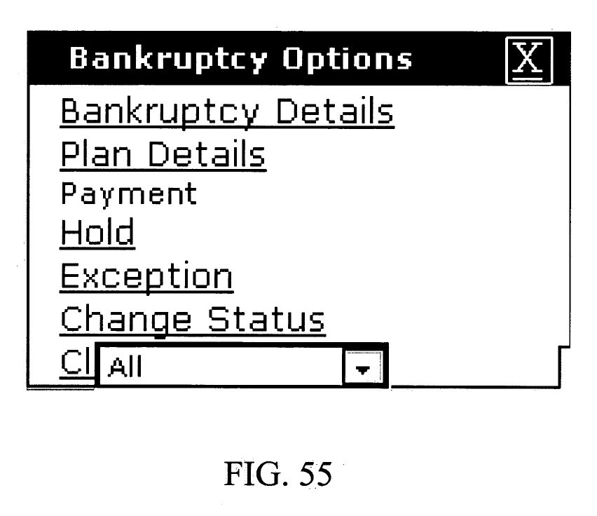

When the bankruptcy case number and filing chapter number are clicked the user will see a layered menu containing all of the tools need for each bankruptcy (FIG. 55).

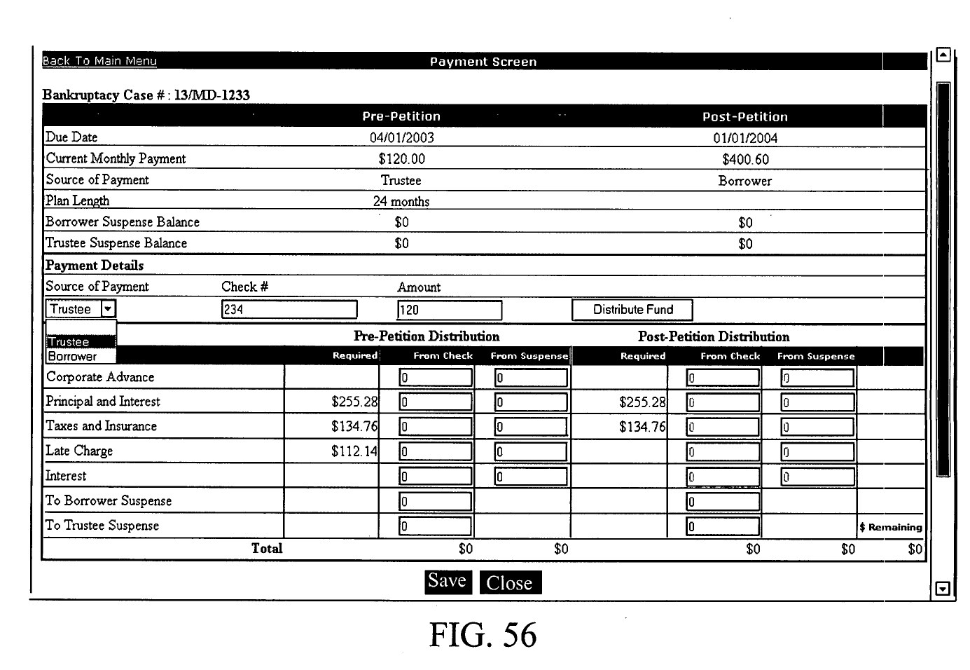

Another unique feature of bankruptcy track zone, which may be accessed from the layered menu, is the ability for the user to collect, document and apply pre-petition and post petition bankruptcy payments (FIG. 56).

### GDS Reports

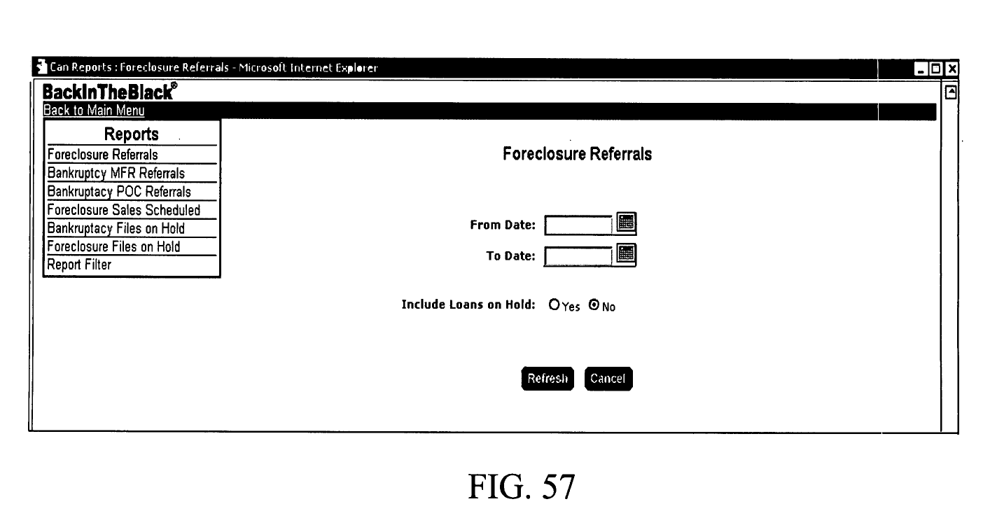

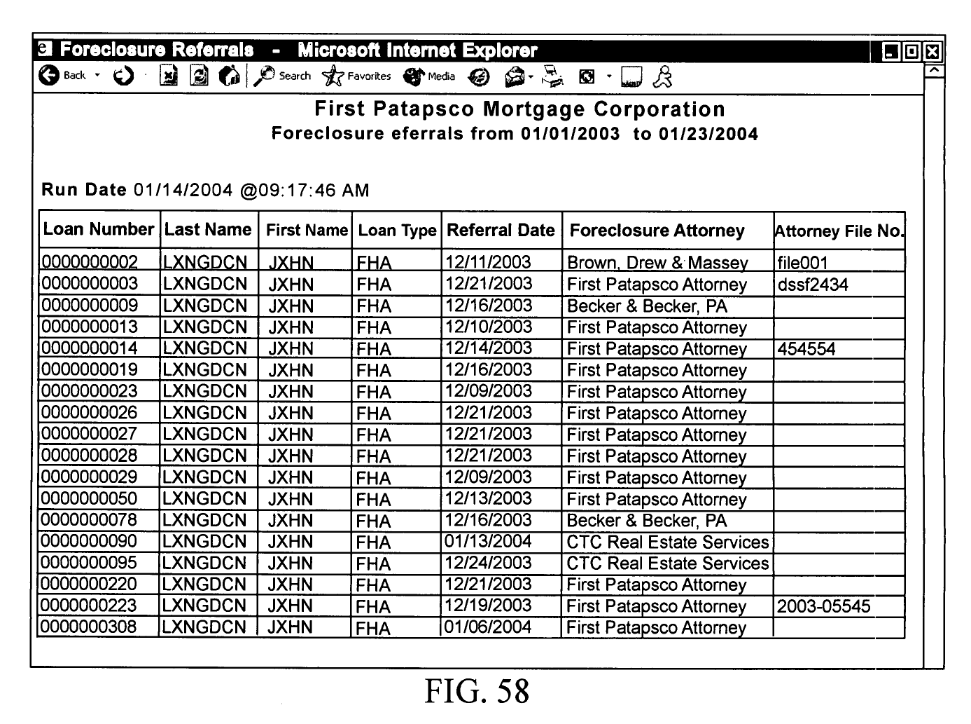

GDS offers pre-defined as well as fully customizable reports. The pre-defined reports such as Foreclosure Referrals and Bankruptcy MFR Referrals may be generated by date range using the entry screen of FIG. 57. After the date range is entered, the user can click the refresh button to view the report. Pre-defined reports display information by loan number and other relevant information (example shown in FIG. 58). These reports may be printed to hard copy by clicking the printer icon on the browser.

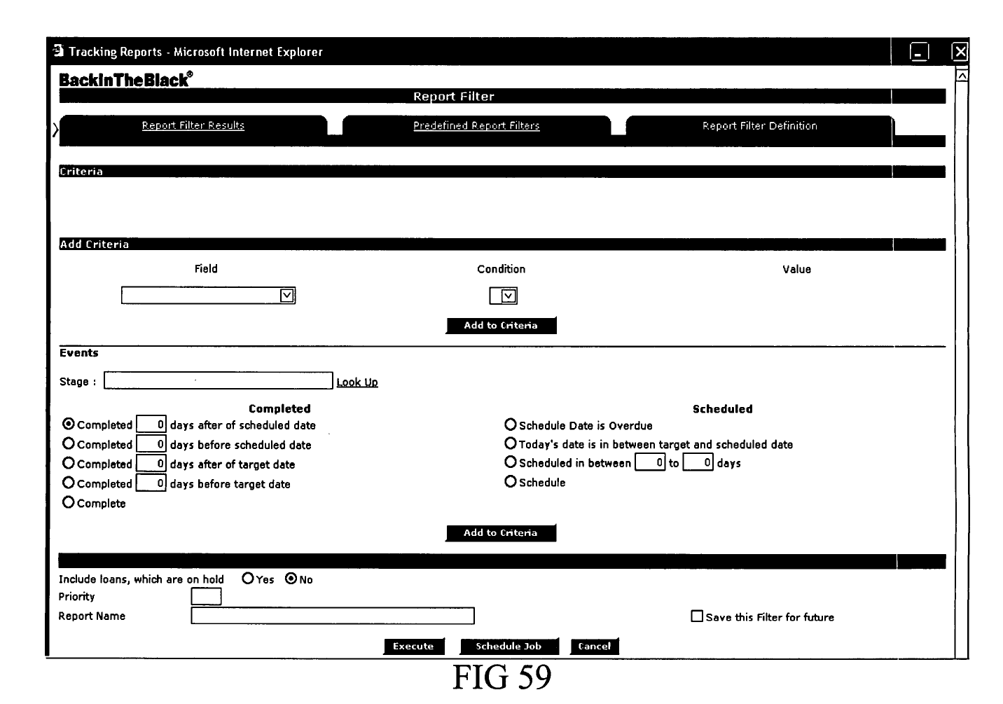

GDS's custom report filter as shown in FIG. 59 provides a flexible means for both the servicer and/or attorney to obtain valuable information pertaining to tracking. These reports may utilize specific loan criteria such as loan type or property state. The user can select various fields for inclusion on the report. This is accomplished with the drop-down Field list under the Add criteria horizon (middle left), which allows the user to add any existing field as a filter criteria. For each selected field the user can also select a condition, plus a value associated with the condition. For example: loan type=FHA. In this case, “loan type” is the field, “=” is the condition and “FHA” is the value. After selecting or entering the field, condition and value, this criterion may be added to the report filter criteria by clicking the Add to Criteria button. The custom report filter supports the inclusion of multiple criteria.

GDS also allows specific tracking Events criteria to be added to the report filter. Any event or “Stage” from any track zone can be found and added with a “completed” or “scheduled” condition using the Events criteria in the lower half of FIG. 59. A look-up function is provided by clicking the look up hyperlink to the right of Stage to locate the specific event. When the event is located in the list and clicked on it will appear in the Stage textbox. The condition may be added by clicking the appropriate scheduled or completed radio button (below and at right). For example: LMT.0000039 Mod Approval Received—Scheduled Date is Overdue. In this example, the result will yield all loans in which mod approval has been received. This criterion may be added to the report filter criteria by clicking the Add to Criteria button.

Before creating the report, the user may choose to include loans that are on hold, determine a priority for the report (1-100) and name the report (see bottom of FIG. 59). After all the criteria have been defined, the user can choose to create the report immediately or schedule the report to be created at a set date and time or interval. Clicking the Execute button will cause the report to be created immediately. To access the results of the report, the user must click the Report Filter Results hyperlink tab from (top left of) the Report Filter Definition screen (FIG. 59).

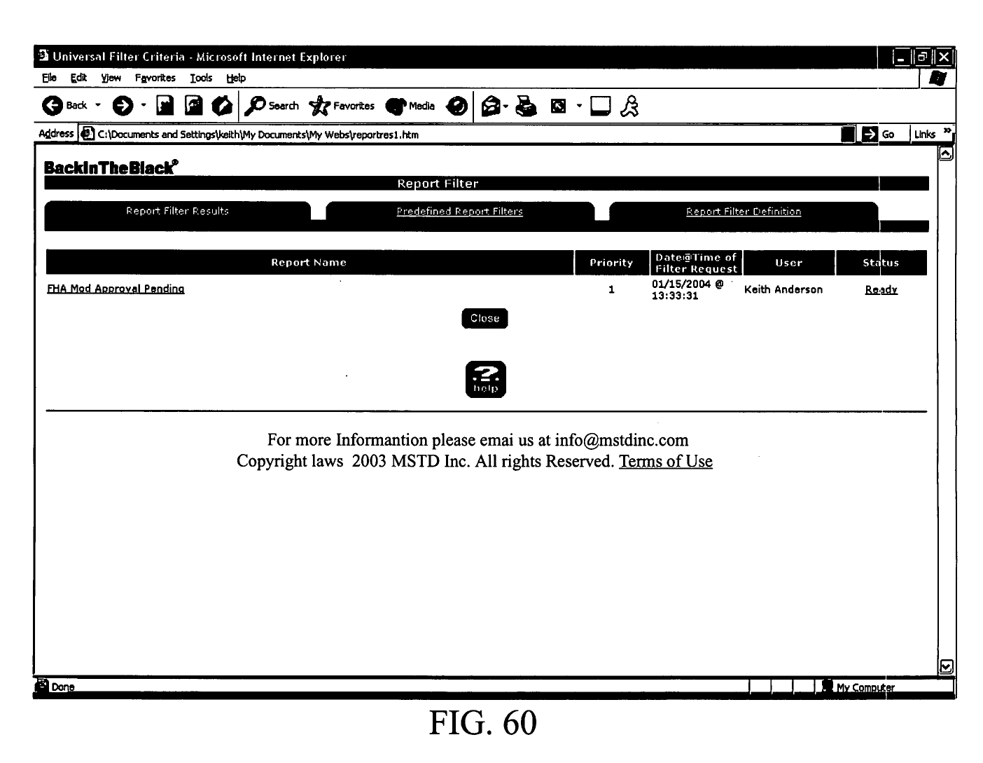

The Report Filter Results screen of FIG. 60 displays reports generated in the GDS. The hyper linked report name may be clicked to view the criteria used in creating the report. To view the report, the user must click the Ready hyperlink (FIG. 60).

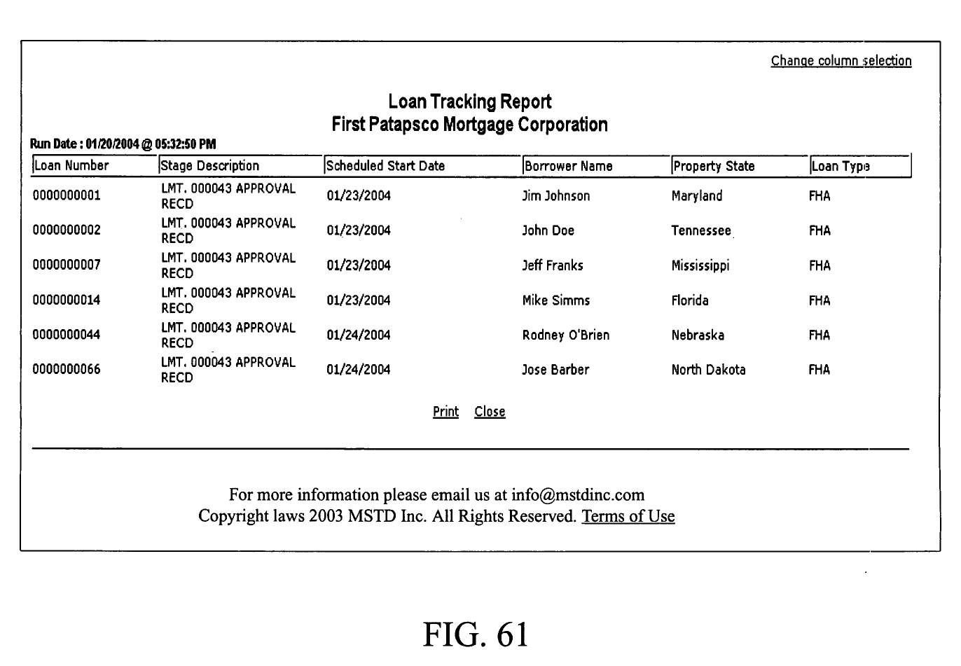

The results of the custom filtered reports appear sorted by default initially (FIG. 61), but can be resorted and with system defined columns added or removed. This can be accomplished by clicking the Change Column Selection hyperlink (top right of FIG. 61). Custom filtered reports are saved for later access within GDS. These reports may be printed to hard copy by clicking the Print hyper link.

### Work Queue's & To Do List

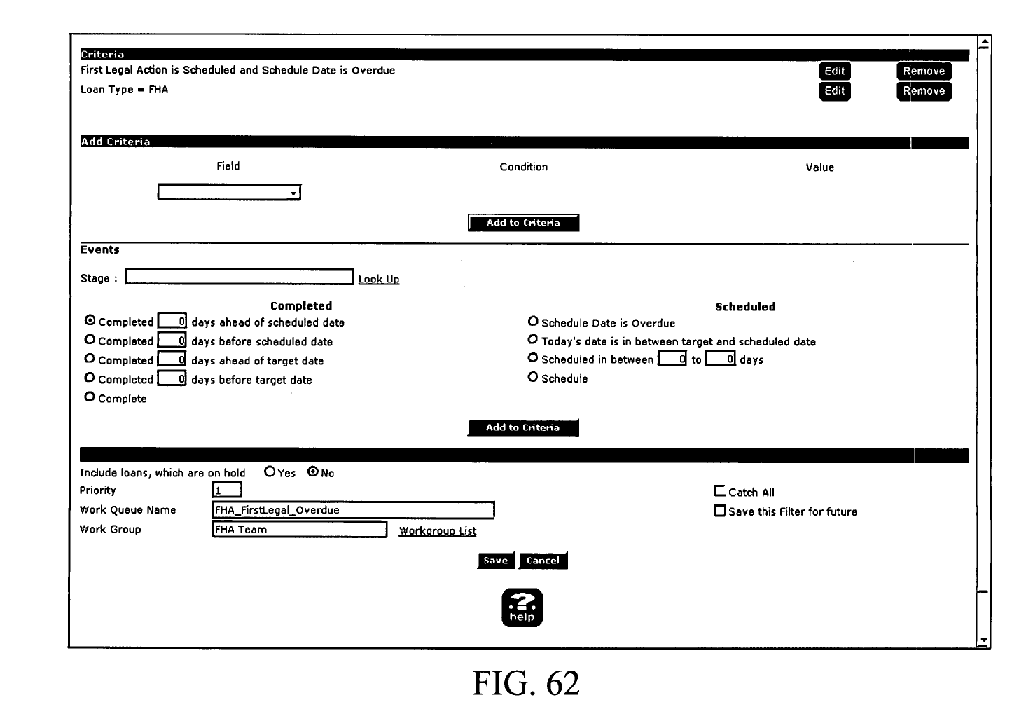

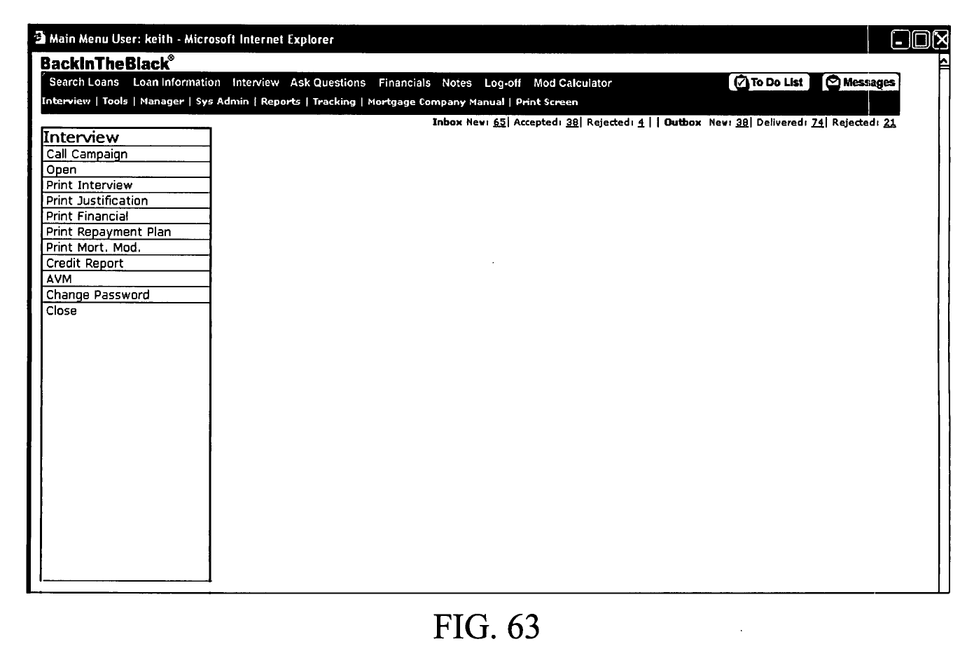

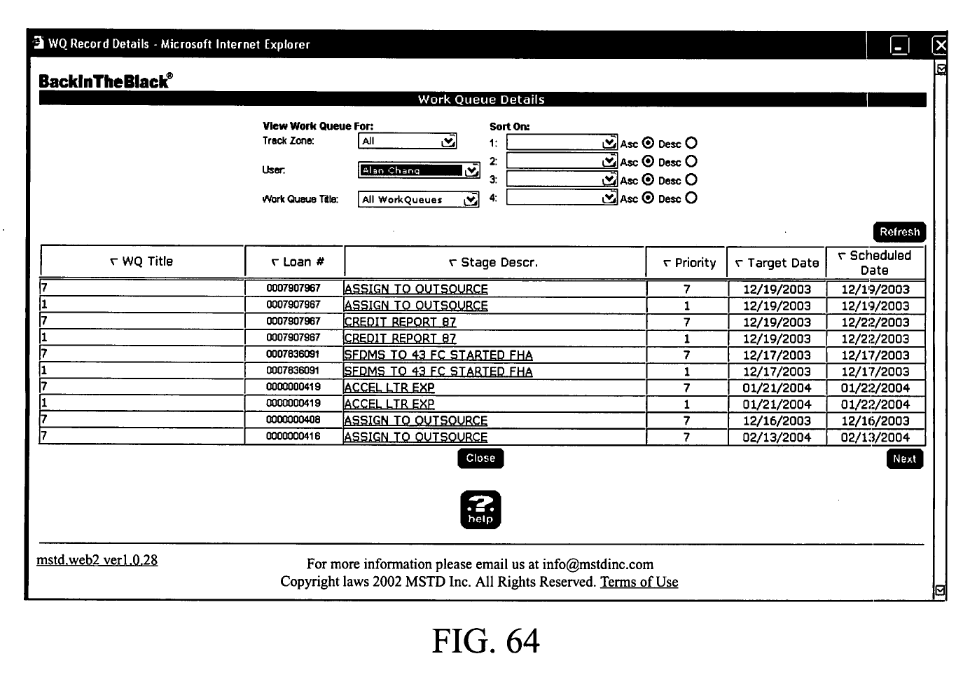

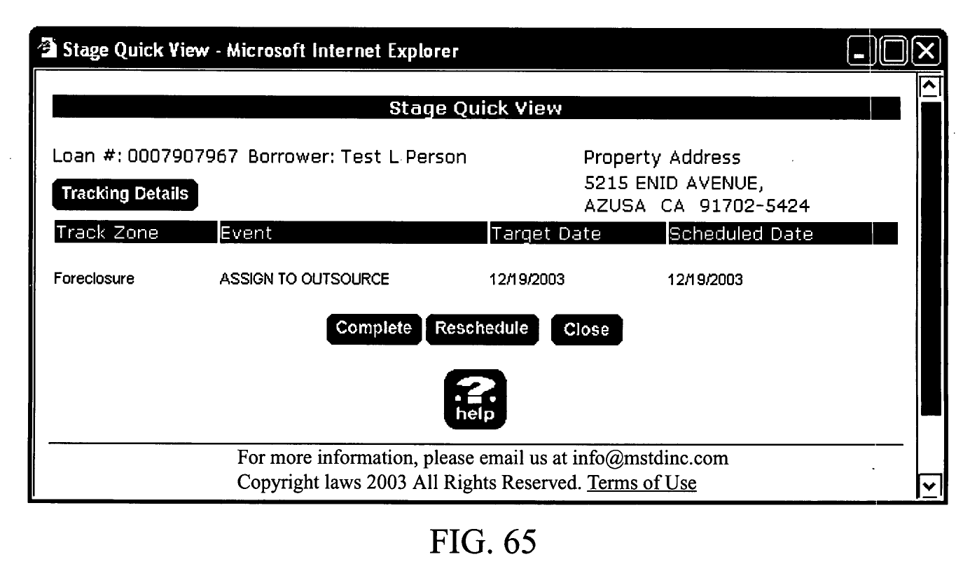

With the extensive default tracking activity and loan information data present, the invention provides a facility for managers to assign work to employees based on mixing and matching of several criteria. All the criteria mentioned in the GDS reports are available to create a work queue or a call campaign, using a filtered GDS report generation screen as shown in FIG. 62. This includes criteria related to loan information and/or criteria related to events. Additionally, the work may be distributed to employees with certain privileges by priority. Creating a work queue or call campaign mimics creating GDS reports with one exception; the criteria is then assigned to a work group. This is accomplished by clicking the workgroup list link shown on FIG. 62. This in turn populates the name of the work group into the work group field. Users are assigned to work groups upon implementation by system administrators in the Sys Admin area of the invention. After a work queue has been created, a user may immediately log into the system and click the To Do List button (top right of FIG. 63). Upon accessing the To Do List, the user will see a list of loans in which an action needs to be completed (FIG. 64). After the user clicks the event, the interface allowing the user to access tracking and complete the event will appear (FIG. 65). The user may decide to reschedule or only make comments about the event as well. Upon taking one of the aforementioned actions, the user will return to the To Do List and continue working on the next loan in the To Do List queue.

### SUMMARY

In summary, the system as a whole increases loan counselor efficiency while decreasing the time and expense necessary to process loss mitigation cases; including identification of the best-case financial workout solution, via the use of logical decision-tree-based interviews, increasing the rate of identification of loss mitigation options, maintaining well-documented compliance with loss mitigation regulations, generating justification reports outlining the critical information that led to the selection of a workout solution, and facilitating the interactions between the several parties involved with a loss mitigation case, all the while acting as a tracking and management system to ensure compliance with the time-sensitive-process steps associated collections, and loss mitigation, and asset recovery. The subject system selects and manages the best default solutions, in real-time, and adheres to rapidly changing industry compliance standards.

Having now fully set forth the preferred embodiments and certain modifications of the concept underlying the present invention, various other embodiments-as well as variations and modifications of the embodiments herein shown and described-obviously will occur to those skilled in the art upon becoming familiar with said underlying concept. It is to be understood, therefore, that the invention may be practiced otherwise than as specifically set forth in the appended claims.

1. A unified loan-default software system for administering problem loans by guided communications among parties including a Mortgage Servicer, Borrower, Guarantor/insurer, and Third-Party Provider, comprising:
a collections module for administering a collections effort by said Mortgage Servicer's loan counselor;
a loss mitigation module for administering a plurality of loss mitigation options;
a Foreclosure module for administering a foreclosure action; and
a Bankruptcy module for administering a bankruptcy action.

2. The unified loan-default software system for administering problem loans according to claim 1, wherein said collections module administers said collections effort to attain any one from among a group of five potential outcomes including no contact with borrower, loan reinstatement, borrower promise to pay, a loan workout, and foreclosure.

3. The unified loan-default software system for administering problem loans according to claim 1, wherein said loss mitigation module administers said loss mitigation options to attain any one from among a group of loss mitigation solutions including reinstatement, special forbearance, loan modification, partial claim, pre-foreclosure sale and deed-in-lieu.

4. A computer communication system for maximizing a return on defaulted loans by facilitating communications between a plurality of participants including Mortgage Servicers, guarantor/insurers, and Third-Party Providers, said system comprising:
a plurality of remote computer stations for each of said participants;
a central server accessible by said plurality of remote computer stations over a communication backbone for generating a plurality of graphical user interfaces for said participants;
a database resident on said central server and containing data quantifying Mortgage Servicer, guarantor/insurer, and government regulatory parameters;
software resident on said central server for guided data entry, tracking, and assessment of loan workout cases based upon said quantifying subscriber, investor, and regulatory parameters.

5. The computer communication system for maximizing a return on defaulted loans according to claim 4, wherein said plurality of graphical user interfaces further comprise a Mortgage Servicer graphical user interface, a guarantor/insurer graphical user interface, and a Third-Party Provider graphical user interface.

6. The computer communication system for maximizing a return on defaulted loans according to claim 5, wherein said Mortgage Servicer graphical user interface comprises a guided interview for guiding a loan counselor through a series of questions to be asked of a borrower all relating to various loss mitigation solutions, various borrower reasons for not repaying a loan, and a data entry mechanism for recording answers thereto.

7. The computer communication system of claim 4, wherein said plurality of remote computer stations for each of said participants communicate over the Internet.

8. The computer communication system of claim 4, wherein said Mortgage Servicer graphical user interface comprises, in combination, 1) a guided interview for guiding a loan counselor through a series of questions to be asked of a borrower all relating to various loss mitigation solutions, various borrower reasons for not repaying a loan, and a data entry mechanism for recording answers thereto; 2) a series of data entry, review, and analysis screens to access said central database and to search, retrieve and update the profile data in said central database in response to user requests.

9. The computer communication system according to claim 8, wherein said
Mortgage Servicer graphical user interface further comprises a loss mitigation module for administering a plurality of loss mitigation options.

10. The computer communication system according to claim 9, wherein said loss mitigation module administers said loss mitigation options to attain any one from among a group of loss mitigation solutions including reinstatement, special forbearance, loan modification, partial claim, pre-foreclosure sale and deed-in-lieu.

11. The computer communication system according to claim 4, wherein said Mortgage Servicer graphical user interface further comprises a Collections module for administering a plurality of collections options.

12. The computer communication system according to claim 11, wherein said collections module administers said collections effort to attain any one from among a group of five potential outcomes including no contact with borrower, loan reinstatement, borrower promise to pay, a loan workout, and foreclosure.

13. The computer communication system according to claim 4, wherein said Mortgage Servicer graphical user interface further comprises a Foreclosure module for administering a foreclosure action.

14. The computer communication system according to claim 4, wherein said Mortgage Servicer graphical user interface further comprises a Bankruptcy module for administering a bankruptcy action.

15. The computer communication system according to claim 6, wherein said Mortgage Servicer graphical user interface further comprises an Eligibility Screen that displays the loss mitigation solutions that the borrower qualifies for under said data quantifying Mortgage Servicer, guarantor/insurer, and government regulatory parameters.

16. The computer communication system according to claim 6, wherein said Mortgage Servicer graphical user interface further comprises a Compare Averages link for comparing a borrower's income and expenses to regional IRS.

17. The computer communication system according to claim 6, wherein said Mortgage
Servicer graphical user interface further comprises a Credit Report Ordering for ordering and downloading a credit report in real time from a selected source.

18. The computer communication system according to claim 6, wherein said Mortgage Servicer graphical user interface further comprises a repayment plan calculator that creates a repayment plan.

19. The computer communication system according to claim 6, wherein said Mortgage Servicer graphical user interface further comprises a Net Present Value (NPV) utility to calculate net present values in a foreclosure situation.

20. The computer communication system according to claim 19, wherein said Net Present Value (NPV) utility allows a choice to calculate net present values in a foreclosure situation by one of a Broker's Price Opinion (BPO) or an Auto Valuation Model (AVM).

20. The computer communication system according to claim 6, wherein said Mortgage Servicer graphical user interface further comprises a global loan-servicing view for reviewing all major aspects of a loan in a default on one screen.

21. The computer communication system according to claim 6, wherein said Mortgage
Servicer graphical user interface further comprises a modification calculator to calculate a payment amount that a borrower can afford.

22. The computer communication system according to claim 6, wherein said Mortgage
Servicer graphical user interface further comprises a Pre Sale calculator for performing calculations for workouts in which the borrower relinquishes the property.

23. The computer communication system according to claim 4, further comprising a foreclosure graphical user interface for allowing attorneys to login and track activities of loans in foreclosure

24. The computer communication system according to claim 4, further comprising a work queue for allowing managers to assign work to employees based on priority.

25. A delinquent loan advisory system, comprising:
a central database for storing profile data inclusive of loan, borrower, property, credit and financial data;
an interface for transmitting said profile data to said central database from a plurality of user devices over a communication network;
a data module for searching the database in response to user requests and retrieving said profile data corresponding to at least one of a particular borrower and a particular loan; and
a Mortgage Servicer graphical user interface including a guided interview for guiding a loan counselor through a series of questions to be asked of said borrower all relating to various loss mitigation solutions, and various borrower reasons for not repaying a loan, and for recording answers thereto;
and wherein said queries assist the user in providing advice regarding a delinquent loan; and
an eligibility check module for analyzing said retrieved profile data, said borrower answers, and said Mortgage Servicer, guarantor/insurer, and government regulatory parameters and for evaluating a plurality of loss mitigation solutions in light of said data and suggesting a best loss mitigation solution therefrom.

26. The system of claim 25, wherein said communication network includes the Internet.

27. The system of claim 25, wherein said Mortgage Servicer graphical user interface including Search Loans, Loan Information, Interview, Ask Questions, Financials, Notes, Logoff, MOD [modification] Calculator, and Notes; sequentially guide a user through the foregoing data entry, review, and analysis steps needed to produce a useful and comprehensive result.

28. The system of claim 25, wherein said Mortgage Servicer graphical user interface comprises a series of selectable index tabs each of which provide direct access to selected modules.

29. The system of claim 25, wherein said Mortgage Servicer graphical user interface provides said Mortgage Servicer with an ability to access said central database and to search, retrieve and update the profile data in said central database in response to user requests.

30. The system according to claim 29, wherein said plurality of graphical user interfaces further comprise a Mortgage Servicer graphical user interface, a guarantor/insurer graphical user interface, and a Third-Party Provider graphical user interface.

31. The system according to claim 29, wherein said Mortgage Servicer graphical user interface comprises a guided interview for guiding a loan counselor through a series of questions to be asked of a borrower all relating to various loss mitigation solutions, various borrower reasons for not repaying a loan, and a data entry mechanism for recording answers thereto.

32. The system of claim 29, wherein said plurality of remote computer stations for each of said participants communicate over the Internet.

33. The system of claim 29, wherein said Mortgage Servicer graphical user interface comprises, in combination, 1) a guided interview for guiding a loan counselor through a series of questions to be asked of a borrower all relating to various loss mitigation solutions, various borrower reasons for not repaying a loan, and a data entry mechanism for recording answers thereto; 2) a series of data entry, review, and analysis screens to access said central database and to search, retrieve and update the profile data in said central database in response to user requests.

34. The system according to claim 29, wherein said
Mortgage Servicer graphical user interface further comprises a loss mitigation module for administering a plurality of loss mitigation options.

35. The computer communication system according to claim 29, wherein said loss mitigation module administers said loss mitigation options to attain any one from among a group of loss mitigation solutions including reinstatement, special forbearance, loan modification, partial claim, pre-foreclosure sale and deed-in-lieu.

36. The computer communication system according to claim 29, wherein said Mortgage Servicer graphical user interface further comprises a Collections module for administering a plurality of collections options.

37. The computer communication system according to claim 36, wherein said collections module administers said collections effort to attain any one from among a group of five potential outcomes including no contact with borrower, loan reinstatement, borrower promise to pay, a loan workout, and foreclosure.

38. The computer communication system according to claim 36, wherein said Mortgage Servicer graphical user interface further comprises a Foreclosure module for administering a foreclosure action.

39. The computer communication system according to claim 36, wherein said Mortgage Servicer graphical user interface further comprises a Bankruptcy module for administering a bankruptcy action.

40. The computer communication system according to claim 36, wherein said Mortgage Servicer graphical user interface further comprises an Eligibility Screen that displays the loss mitigation solutions that the borrower qualifies for under said data quantifying Mortgage Servicer, guarantor/insurer, and government regulatory parameters.

41. The computer communication system according to claim 36, wherein said Mortgage Servicer graphical user interface further comprises a Compare Averages link for comparing a borrower's income and expenses to regional IRS .

42. The computer communication system according to claim 36, wherein said Mortgage
Servicer graphical user interface further comprises a Credit Report Ordering for ordering and downloading a credit report in real time from a selected source.

43. The computer communication system according to claim 36, wherein said Mortgage Servicer graphical user interface further comprises a repayment plan calculator that creates a repayment plan.

44. The computer communication system according to claim 36, wherein said Mortgage Servicer graphical user interface further comprises a Net Present Value (NPV) utility to calculate net present values in a foreclosure situation.

45. The computer communication system according to claim 44, wherein said Net Present Value (NPV) utility allows a choice to calculate net present values in a foreclosure situation by one of a Broker's Price Opinion (BPO) or an Auto Valuation Model (AVM).

45. The computer communication system according to claim 36, wherein said Mortgage Servicer graphical user interface further comprises a global loan-servicing view for reviewing all major aspects of a loan in a default on one screen.

46. The computer communication system according to claim 36, wherein said Mortgage Servicer graphical user interface further comprises a modification calculator to calculate a payment amount that a borrower can afford.

47. The computer communication system according to claim 36, wherein said Mortgage
Servicer graphical user interface further comprises a Pre Sale calculator for performing calculations for workouts in which the borrower relinquishes the property.

48. The computer communication system according to claim 36 further comprising a foreclosure graphical user interface for allowing attorneys to login and track activities of loans in foreclosure

49. The computer communication system according to claim 36, further comprising a work queue for allowing managers to assign work to employees based on priority.

50. A method for administering a best loss mitigation solutions relating to delinquent loan data, said method including the steps of:
maintaining a database of borrower profile data including personal and financial data, property data, loan data and credit data,;
searching the database in response to a user request and retrieving said profile data corresponding to at least one of a particular borrower and a particular loan;
building a plurality of structured queries for said borrower relating to various loss mitigation solutions including forbearance, mortgage modification, partial claim, pre-foreclosure sale and deed-in-lieu, and to various borrower reasons for not repaying a loan;
storing user responses to said queries at the database; and
analyzing said retrieved profile data and said borrower responses, evaluating all of said loss mitigation solutions including forbearance, mortgage modification, partial claim, pre-foreclosure sale and deed-in-lieu, and determining an optimal loss mitigation solution for a specific, delinquent loan; and
providing each user using a client device access to the database consistent with its role in the transaction.
